(19) United States
(12) Patent Application Publication
(10) Pub. No.: US 2024/0338698 A1
(43) Pub. Date: Oct. 10, 2024

(54) SYSTEM AND METHOD FOR PERSONAL IDENTIFICATION NUMBER ENTRY IN A COMMERCIAL OFF THE SHELF COMMUNICATION DEVICE

(71) Applicant: Stripe, Inc., South San Francisco, CA (US)

(72) Inventors: Hwai Sian Tsai, Hong Kong (HK); Chi Wah Lo, Hong Kong (HK)

(21) Appl. No.: 18/578,637

(22) PCT Filed: Jul. 15, 2022
(86) PCT No.: PCT/CN2022/105864

§ 371 Date: Jan. 11, 2024

Related U.S. Application Data
(60) Provisional application No. 63/222,519, filed on Jul. 16, 2021.

(51) Int. Cl. G06Q 20/40

(52) U.S. Cl. CPC G06Q 20/4012; G06Q 20/4015

(57) ABSTRACT

A system for conducting a card transaction comprises an consumer application running on a user device, a card reading interface separate from the user device, a payment application residing on a COTS device, a PIN verification subsystem, an EPB creation subsystem located at an EPB creation location, and a server. The user device receives an entered PIN. The card reading interface receives a PAN from a payment card. Either the PIN or a first set of signals comprising the PIN is received by the EPB creation subsystem. The second set of signals comprising the PAN is generated and transmitted by the payment application via the network. An EPB is created by the EPB creation subsystem based on the PIN and PAN, and the EPB is transmitted by the EPB creation subsystem to either the PIN verification subsystem or the payment card for PIN verification.

### CROSS-REFERENCE TO RELATED APPLICATIONS

This application is a national stage of International Application No. PCT/CN2022/105864, filed on Jul. 15, 2022, which claims priority to U.S. Provisional Application No. 63/222,519, filed on Jul. 16, 2021. Both of the aforementioned applications are hereby incorporated by reference in their entireties.

### TECHNICAL FIELD

The present disclosure relates to software-based personal identification number (PIN) entry on commercial off-the-shelf (COTS) devices.

### SUMMARY

In one aspect, a system for conducting a card transaction includes a consumer application running on a user device, a card reading interface separate from the user device, a payment application residing on a commercial-off-the-shelf (COTS) device, a personal identification number (PIN) verification subsystem, an encrypted PIN block (EPB) creation subsystem located at an EPB creation location, and a server. The user device, the card reading interface, the COTS device, the EPB creation subsystem and the server are coupled via at least one of a network or a connection. The user device receives an entered PIN, the card reading interface receives a personal account number (PAN) from a payment card, either the PIN or a first set of signals comprising the PIN is received by the EPB creation subsystem, wherein the first set of signals is generated by the user device and transmitted to the EPB creation subsystem via the network. Either the PAN or a second set of signals comprising the PAN is received by the EPB creation subsystem, wherein either the second set of signals is generated and transmitted by the card reading interface via one of the network or the connection, or the PAN is relayed to the payment application via at least one of the network and the connection, and the second set of signals comprising the PAN is generated and transmitted by the payment application via the network. An EPB is created by the EPB creation subsystem based on the PIN and the PAN, and the EPB is transmitted by the EPB creation subsystem to either the PIN verification subsystem or the payment card for PIN verification

In another aspect, a system for location diversification of performance of a card transaction includes a personal identification number (PIN) reception subsystem at a PIN reception location, a personal account number (PAN) reception subsystem at a PAN reception location, wherein the PIN reception location is different from the PAN reception location, a payment application residing on a commercial-off-the-shelf (COTS) device, a PIN verification subsystem, an encrypted PIN block (EPB) creation subsystem located at an EPB creation location, and a server. The PIN reception subsystem, the PAN reception subsystem, the COTS device, the EPB creation subsystem and the server are coupled via at least one of a network or a connection. The PIN reception subsystem receives an entered PIN, the PAN reception subsystem receives a PAN from a payment card, either the PIN or a first set of signals comprising the PIN is received by the EPB creation subsystem, wherein the first set of signals is generated and transmitted to the EPB creation subsystem via the network. Either the PAN or a second set of signals comprising the PAN is received by the EPB creation subsystem, wherein either the second set of signals is generated and transmitted by the card reading interface via one of the network or the connection, or the PAN is relayed to the payment application via at least one of the network and the connection, and the second set of signals comprising the PAN is generated and transmitted by the payment application via the network. An EPB is created by the EPB creation subsystem based on the PIN and the PAN, and the EPB is transmitted by the EPB creation subsystem to either the PIN verification subsystem or the payment card for PIN verification.

In another aspect, a method for conducting a card transaction includes receiving, by a personal identification number (PIN) reception subsystem, an entered PIN, receiving, by a personal account number (PAN) reception subsystem, a PAN from a payment card, receiving, by an encrypted PIN block (EPB) creation subsystem, either the PIN or a first set of signals comprising the PIN wherein the first set of signals is generated by the PIN reception subsystem and transmitted to the EPB creation subsystem, receiving, by the EPB creation subsystem, either the PAN or a second set of signals comprising the PAN, wherein either the second set of signals is generated and transmitted by the PAN capture subsystem, or the PAN is relayed to a payment application by the PAN reception subsystem, and the second set of signals comprising the PAN is generated and transmitted by the payment application, creating, by the EPB creation subsystem, an EPB based on the PIN and the PAN, and transmitting, by the EPB creation subsystem, the EPB to either a PIN verification subsystem or the payment card for PIN verification.

In another aspect, a system for conducting a card transaction includes a consumer application running on a user device, a card reading interface separate from the user device, a payment application residing on a commercial-off-the-shelf (COTS) device, a personal identification number (PIN) verification subsystem, an encrypted PIN block (EPB) creation subsystem located at an EPB creation location, and a server. The user device, the card reading interface, the COTS device, the EPB creation subsystem and the PIN verification subsystem are coupled via at least one of a network or a connection. The user device receives an entered PIN, the card reading interface receives a personal account number (PAN) from a payment card, either the PIN or a first set of signals comprising the PIN is received by the EPB creation subsystem, wherein the first set of signals is generated by the user device and transmitted to the EPB creation subsystem via the network, an EPB is created by the EPB creation subsystem based on the PIN, and the EPB is transmitted by the EPB creation subsystem to either the PIN verification subsystem or the payment card for PIN verification.

The foregoing and additional aspects and embodiments of the present disclosure will be apparent to those of ordinary skill in the art in view of the detailed description of various embodiments and/or aspects, which is made with reference to the drawings, a brief description of which is provided next.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, an image sensor, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding, reference is now made to the following description taken in conjunction with the accompanying Drawings in which:

FIG. 1 illustrates an example of a system to enable secure PIN entry in accordance with various embodiments of this disclosure;

FIG. 2A illustrates an example embodiment of a commercial off the shelf (COTS) device in accordance with various embodiments of this disclosure;

FIG. 2B illustrates an example embodiment of a user device in accordance with various embodiments of this disclosure;

FIG. 2C illustrates an example system to enable downloading and installing of a payment application on a COTS device using a secure process for application installation and updating in accordance with various embodiments of this disclosure;

FIG. 2D illustrates an example of a COTS device incorporating an application installation controller in accordance with various embodiments of this disclosure;

FIG. 2E illustrates an example of a process for vendor distribution of applications in accordance with various embodiments of this disclosure;

FIG. 2F illustrates an example of a process to prevent a sensitive portion of an application from running on one or more unauthorized devices in accordance with various embodiments of this disclosure;

FIG. 2G illustrates an example of segregation of an application into different classes and utilization of application level sandboxes in accordance with various embodiments of this disclosure;

FIG. 2H illustrates an example of a method for vendor upload of applications incorporating classification of applications for different sandboxes in accordance with various embodiments of this disclosure;

FIG. 3 illustrates an example embodiment of a process for payment in accordance with various embodiments of this disclosure;

FIG. 4A illustrates an example of a COTS device which incorporates a randomization subsystem in accordance with various embodiments of this disclosure;

FIG. 4B illustrates an example of a keypad displayed on a touchscreen in accordance with various embodiments of this disclosure;

FIG. 4C illustrates a detailed example of a keypad in accordance with various embodiments of this disclosure;

FIG. 4D illustrates an example of a process to randomly select the width of a button in accordance with various embodiments of this disclosure;

FIG. 4E illustrates an example of a process to randomly select the height of a button in accordance with various embodiments of this disclosure;

FIG. 4F illustrates an example of a process to select row heights and column widths in series in accordance with various embodiments of this disclosure;

FIG. 4G illustrates an example of a process to select row heights and column widths in parallel in accordance with various embodiments of this disclosure;

FIG. 4H illustrates a starting position for a keypad in accordance with various embodiments of this disclosure;

FIG. 4I illustrates an example of rolling up rows on a keypad in accordance with various embodiments of this disclosure;

FIG. 4J illustrates an example of flipping columns on a keypad in accordance with various embodiments of this disclosure;

FIG. 4K illustrates an example of a left to right mirrored keypad in accordance with various embodiments of this disclosure;

FIG. 4L illustrates an example of a vertically mirrored keypad in accordance with various embodiments of this disclosure;

FIG. 4M illustrates an example of random selection of two or more display parameters in combination in accordance with various embodiments of this disclosure;

FIG. 4N illustrates an example of a sequence for a random selection of combinations of display parameters in accordance with various embodiments of this disclosure in accordance with various embodiments of this disclosure;

FIG. 5A illustrates reception of personal identification number (PIN) and personal account number (PAN) at different locations in accordance with various embodiments of this disclosure; and

FIG. 5B illustrates an example process for PIN verification for offline and online PIN verification in accordance with various embodiments of this disclosure;

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Referring now to the drawings, wherein like reference numbers are used herein to designate like elements throughout, the various views and embodiments of a system and a method for personal identification number entry in a commercial off the shelf communication device are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

In payment processes which utilize payment cards, usually the identification of the cardholder has to be verified. The following Cardholder Verification (CV) methods are usually used:
Signature verification, that is, where the cardholder signs his or her name on a piece of paper (on a receipt or an invoice), or
Personal Identification Number (PIN) verification, that is, where the cardholder enters his or her PIN on a secure PIN pad.

Typically, an authentication process is based on the following 3 factors, or answering the following questions:
What I know, or the knowledge factor;
What I have, or the possession factor; and
What I am, or the inherence factor.

A traditional Electronics Fund Transfer Point of Sale (EFTPOS) device is used to capture card information as well as the PIN. Traditional EFTPOS devices are however expensive and have limited mobility.

A Mobile Point of Sale (MPOS) device is a more mobile version of a traditional EFTPOS device. An MPOS device is typically used together with a mobile device such as a mobile phone or tablet, and the MPOS device is typically used to read cards and PIN entry, while functions such as communication and more complicated user interfaces are shifted to the mobile device. This has led to a lower cost and more mobile solution for accepting PINs.

The Payment Card Industries Security Standards Council (PCI SSC) announced a new PCI Security Standard for software-based PIN entry on commercial off-the-shelf (COTS) devices. This standard is known as the Software-based PIN entry on Commercial Off The Shelf (SPoC) standard. The SPoC standard provides guidelines for PIN entry on a touch screen of a mobile phone or tablet without needing a physically secure PIN pad. It is also loosely referred to as PIN on Mobile (POM) or PIN on Glass (PoG). This has further reduced cost compared to the MPOS solution.

More recent solutions have proposed acceptance of contactless card or wallet by using the NFC capability of a mobile device, in addition to accepting the PIN. This further reduces or eliminates the need for any dedicated hardware. However, this could be a security concern, as card data and PIN can be compromised at a single smart device which is not designed with protections according to payment devices' standards. This increases the severity of incidents if the card data is not randomised in any way such as by tokenisation.

Therefore, solutions such as SPoC systems which have shifted the PIN entry interface to a merchant-side mobile device still raise some consumer concern on the privacy protection of their PIN. This is in spite of being secured by several technical and management measures.

Solutions which accept card data and a PIN in the same device raise an even greater concern, as clear text card data and the PIN can be compromised at a single point. This is true, unless the card data is protected in other means such as tokenizing the Personal Account Number (PAN).

The following describes a system and method to solve the problems described above. The system and method enables reception or capture of card data and PIN at different locations, and combination of these different pieces of data to enable, for example, PIN verification and transaction approval, thereby enabling location diversification during performance of card transactions. The system and method also minimizes risk of compromising both PIN and PAN within the perimeter of a single smart device which may not be designed with the protections seen in standard commercial payment devices. The system and method also enables replacement of a potentially expensive single secured payment device such as an EFTPOS terminal, with cheaper off-the-shelf devices. It also alleviates consumer concerns around shifting the PIN entry interface to a merchant-side mobile device. Finally, by receiving card data and PIN in different devices, it reduces the risk of compromise from receiving clear text card data and PIN at a single point. This leads to more secure PIN entry.

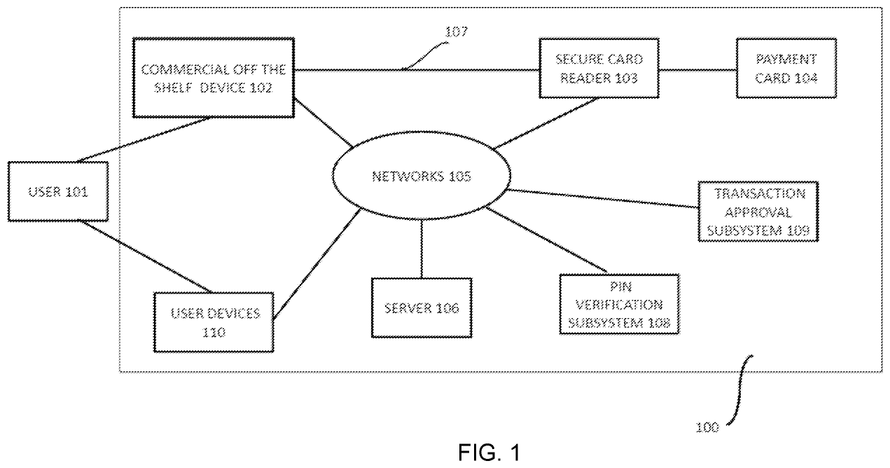

FIG. 1 illustrates an example of a system 100 to enable secure PIN entry in accordance with various embodiments of this disclosure. In FIG. 1, user 101 interfaces with commercial off the shelf (COTS) device 102 to, for example, make payments. COTS device 102 is, for example, a smartwatch, smartphone, tablet, laptop, or any appropriate computing and network-enabled device.

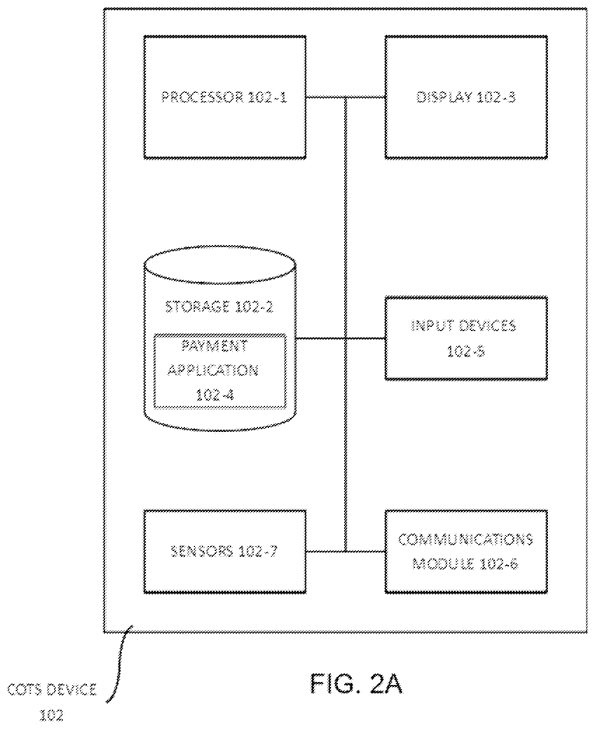

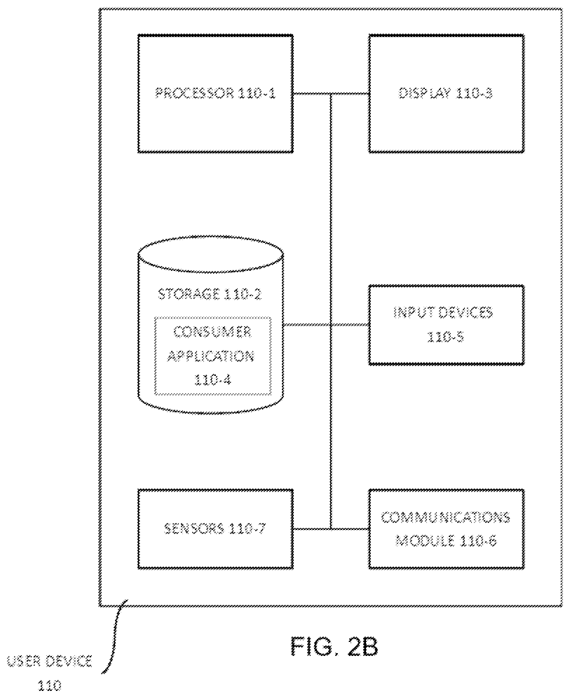

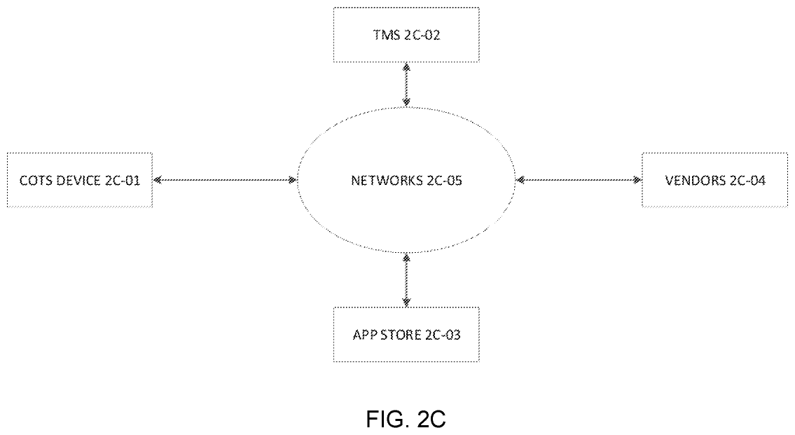

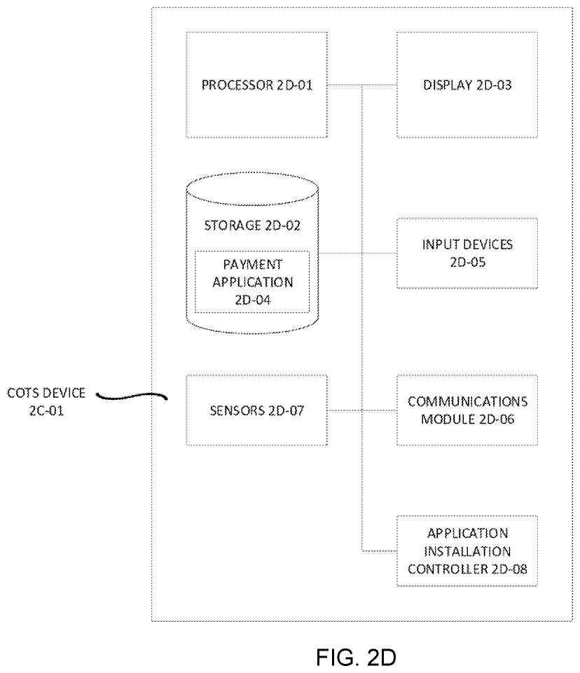

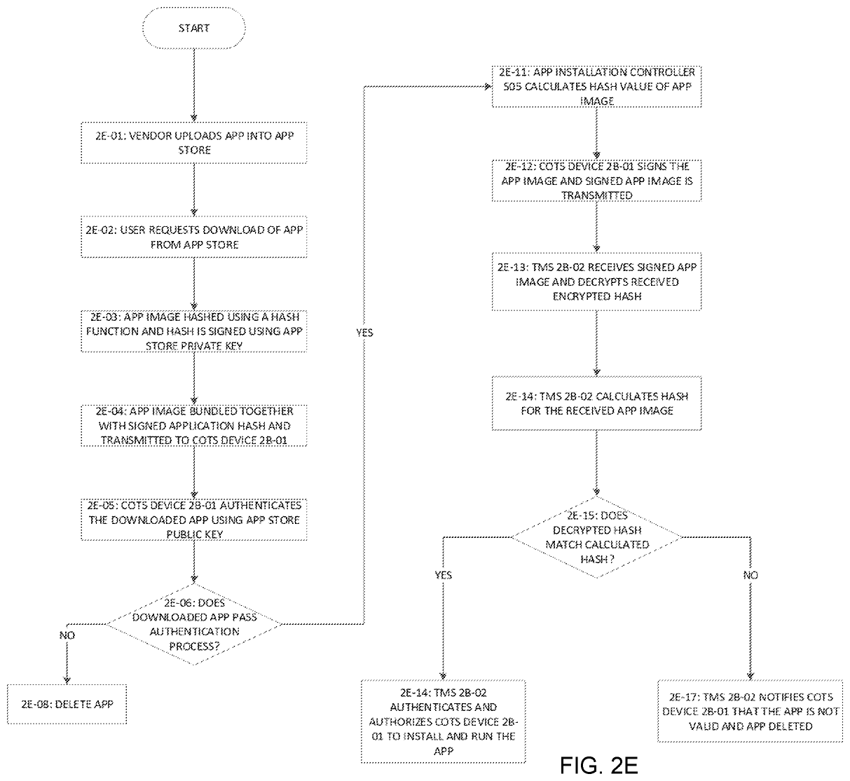

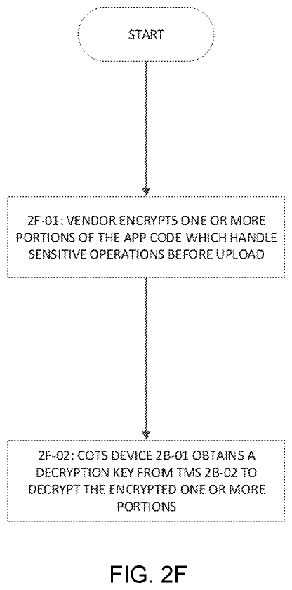

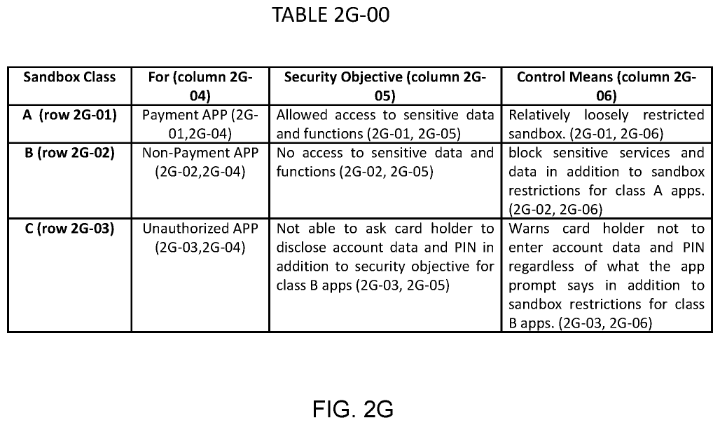

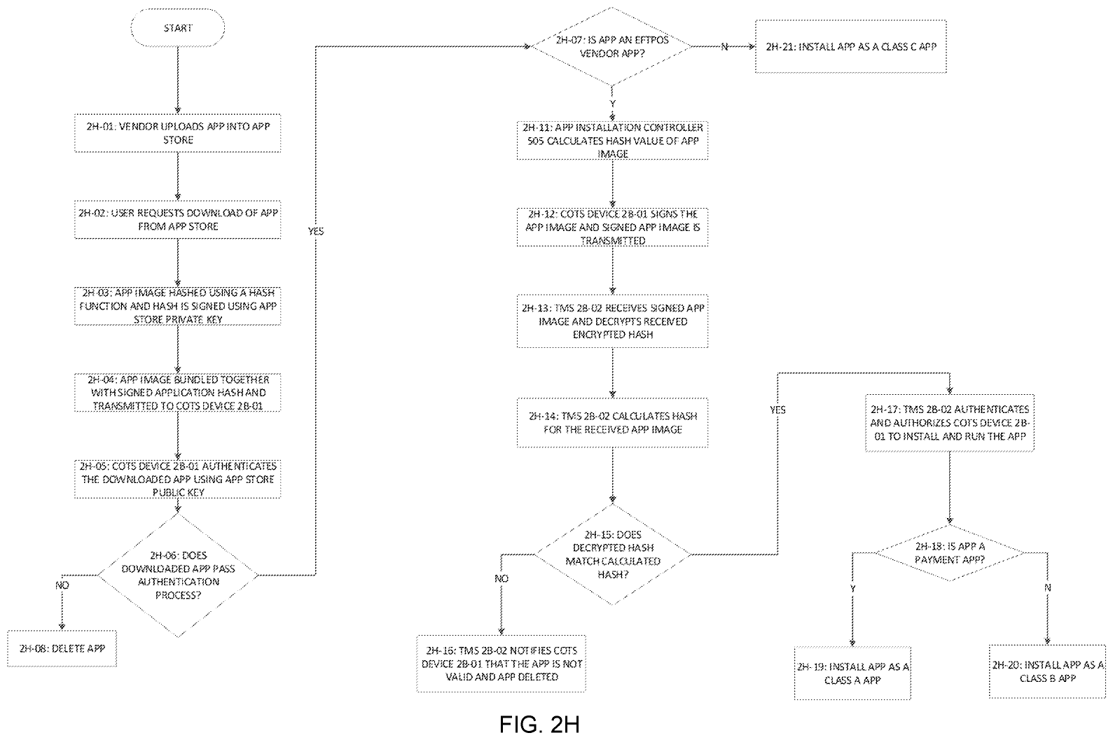

An example embodiment of COTS device 102 is shown in FIG. 2A. In FIG. 2A, processor 102-1 performs processing functions and operations necessary for the operation of COTS device 102, using data and programs stored in storage 102-2. An example of such a program is payment application 102-4, which will be described in further detail below. Display 102-3 performs the function of displaying data and information for user 101. Input devices 102-5 allow user 101 to enter information. This includes, for example, devices such as a touch screen, mouse, keypad, keyboard, microphone, camera, video camera and so on. In some embodiments, display 102-3 is a touchscreen which means it is also part of input devices 102-5. Communications module 102-6 allows COTS device 102 to communicate with devices and networks external to COTS device 102. This includes, for example, communications via BLUETOOTH®, Wi-Fi, Near Field Communications (NFC), Radio Frequency Identification (RFID), 3G, Long Term Evolution (LTE), Universal Serial Bus (USB) and other protocols known to those of skill in the art. Sensors 102-7 perform functions to sense or detect environmental or locational parameters. Sensors 102-7 include, for example, accelerometers, gyroscopes, magnetometers, barometers, Global Positioning System (GPS), proximity sensors and ambient light sensors. The components of COTS device 102 are coupled to each other as shown in FIG. 2A. COTS device 102 is coupled to the other components of system 100 via, for example, networks 105 which will be described further below.

Returning to FIG. 1, card reading interface 103 is communicatively coupled to COTS device 102 via either connection 107 or networks 105. In some embodiments, card reading interface 103 is part of COTS device 102. In certain embodiments, card reading interface 103 is coupled to server 106 and the other components of system 100 via networks 105. Card reading interface 103 is functional to read card data such as PANs from payment cards such as payment card 104. Card reading interface 103 then comprises a card data reception subsystem to receive card data. Payment card 104 is, for example, a physical or virtual credit card or a debit card. In some embodiments, payment card 104 has a chip, such as an Europay Mastercard Visa (EMV) chip. In yet other embodiments, payment card 104 has a magnetic stripe. In yet other embodiments, payment card 104 is enabled for near field communications (NFC). Card reading interface 103 performs the reading of payment card data using techniques comprising contact interfaces, contactless or NFC interfaces, magnetic swipe reading, camera interfaces to capture Quick Response (QR) codes, Bluetooth, and other payment card data reading techniques known to those of skill in the art.

In some embodiments, card reading interface 103 comprises an EPB creation subsystem to encrypt a PIN into a format called Encrypted PIN Block (EPB). This EPB creation subsystem is implemented using, for example, hardware, software or a combination of hardware and software residing in the card reading interface 103. The details of operation of this subsystem will be further explained below.

Networks 105 plays the role of communicatively coupling the various components of system 100. Networks 105 can be implemented using a variety of networking and communications technologies. In some embodiments, networks 105 are implemented using wired technologies such as Firewire, Universal Serial Bus (USB), Ethernet and optical networks. In some embodiments, networks 105 are implemented using wireless technologies such as WiFi, BLUETOOTH®, NFC, 3G, LTE and 5G. In some embodiments, networks 105 are implemented using satellite communications links. In some embodiments, the communication technologies stated above include, for example, technologies related to a local area network (LAN), a campus area network (CAN) or a metropolitan area network (MAN). In yet other embodiments, networks 105 are implemented using terrestrial communications links. In some embodiments, networks 105 comprise at least one public network. In some embodiments, networks 105 comprise at least one private network. In some embodiments, networks 105 comprise one or more subnetworks. In some of these embodiments, some of the subnetworks are private. In some of these embodiments, some of the subnetworks are public. In some embodiments, communications within networks 105 are encrypted.

As explained above, in some embodiments COTS device 102 is communicatively coupled to card reading interface 103 via, for example, connection 107 or networks 105. Connection 107 is implemented using technologies which enable communicative coupling between COTS device 102 and card reading interface 103. Examples of connection 107 include:
A connection via an audio jack on COTS device 102,
A connection via a Universal Serial Bus (USB) or Firewire connection on COTS device 102,
A BLUETOOTH® connection,
An NFC connection, and
A Wi-Fi connection.

Server 106 performs back-end processing as necessary to coordinate the interworking of COTS device 102 and user device 110. Examples of back-end processing operations comprise, for example, PIN and card data encryption and format conversion as necessary. This back-end processing is performed to facilitate, for example, payment flows and cardholder verification. In some embodiments, server 106 comprises an EPB creation subsystem. The details of operation of this subsystem will be further explained below. As previously stated, in some embodiments server 106 is coupled to card reading interface 103 via networks 105. In some embodiments, server 106 is coupled to COTS device 102 via networks 105. Server 106 can be implemented in a variety of ways. In some embodiments, server 106 is implemented using a single server. In other embodiments, server 106 is implemented using a plurality of devices. In some embodiments, server 106 is implemented using some combination of hardware and software. In yet other embodiments, server 106 is implemented in a distributed fashion, whereby the components of server 106 are situated at one or more locations. Server 106 may also be coupled to the other components of system 100 via networks 105.

User device 110 is a device associated with the user. These include, for example, smartwatches, smartphones, tablets, laptops, desktops or any appropriate computing and network-enabled device. In some embodiments, user device 110 is communicatively coupled to networks 105 so as to transmit communications to, and receive communications from networks 105. In some embodiments, user device 110 comprises an EPB creation subsystem. This EPB creation subsystem is implemented using, for example, hardware, software or a combination of hardware and software residing in user device 110. The details of operation of this subsystem will be further explained below. In some embodiments, user device 110 comprises a PIN reception subsystem to receive PINs entered by the user. User device 110 may be coupled to the other components of system 100 via networks 105.

An example embodiment of user device 110 is shown in FIG. 2B. In FIG. 2B, processor 110-1 performs processing functions and operations necessary for the operation of user device 110, using data and programs stored in storage 110-2. An example of such a program is consumer application 110-4, which will be described in further detail below. Display 110-3 performs the function of displaying data and information for user 101. Input devices 110-5 allow user 101 to enter information such as a PIN. This includes, for example, devices such as a touch screen, mouse, keypad, keyboard, microphone, camera, video camera and so on. In some embodiments, display 110-3 is a touchscreen which means it is also part of input devices 110-5. Communications module 110-6 allows user device 110 to communicate with devices and networks external to user device 110. This includes, for example, communications via BLUETOOTH®, Wi-Fi, Near Field Communications (NFC), Radio Frequency Identification (RFID), 3G, Long Term Evolution (LTE), Universal Serial Bus (USB) and other protocols known to those of skill in the art. Sensors 110-7 perform functions to sense or detect environmental or locational parameters. Sensors 110-7 include, for example, accelerometers, gyroscopes, magnetometers, barometers, Global Positioning System (GPS), proximity sensors and ambient light sensors. The components of user device 110 are coupled to each other as shown in FIG. 2B.

Returning to FIG. 1, in some embodiments as mentioned above, payment card 104 is a virtual card. Then in some of the embodiments where payment card 104 is a virtual card, payment card 104 is stored on user device 110.

PIN verification subsystem 108 is a subsystem associated with a card issuer to perform on-line PIN verification. PIN verification subsystem 108 can be implemented in a variety of ways. In some embodiments, PIN verification subsystem 108 is implemented using a single server. In other embodiments, PIN verification subsystem 108 is implemented using a plurality of devices. In some embodiments, PIN verification subsystem 108 is implemented using some combination of hardware and software. In yet other embodiments, PIN verification subsystem 108 is implemented in a distributed fashion, whereby the components of PIN verification subsystem 108 are situated at one or more locations. PIN verification subsystem 108 is communicatively coupled to the other components of system 100 via networks 105.

Transaction approval subsystem 109 is a subsystem associated with a card issuer to perform transaction approval. Transaction approval can be on-line or off-line. In the case of an on-line transaction, the transaction details are transferred to the transaction approval subsystem 109 for approval in real-time. For an off-line transaction, the transaction details do not have to be passed to the transaction approval subsystem 109 for approval in real time, but are settled with the card issuer and the transaction approval subsystem 109 at a later time. Transaction approval subsystem 109 can be implemented in a variety of ways. In some embodiments, transaction approval subsystem 109 is implemented using a single server. In other embodiments, transaction approval subsystem 109 is implemented using a plurality of devices. In some embodiments, transaction approval subsystem 109 is implemented using some combination of hardware and software. In yet other embodiments, transaction approval subsystem 109 is implemented in a distributed fashion, whereby the components of transaction approval subsystem 109 are situated at one or more locations. Transaction approval subsystem 109 is communicatively coupled to the other components of system 100 via networks 105.

Payment application 102-4 of FIG. 2A will now be discussed in more detail. Payment application 102-4 is functional to implement a payment process for a vendor. It serves to accept price inputs, calculate price totals and so on. In some embodiments, it also performs functions such as displaying a PIN pad for the user to enter a PIN. It also interacts with card reading interface 103 as necessary and transmits prompts to other devices and to other components of FIG. 1 such as server 106 as necessary. In some embodiments, payment application 102-4 comprises an EPB creation subsystem, the operation of which will be discussed further in detail below. In some embodiments, this EPB creation subsystem is implemented using, for example, software which is part of payment application 102-4.

In other embodiments, this EPB creation subsystem is implemented using a combination of:
software which is part of payment application 102-4, and
other hardware components of COTS device 102 such as processor 102-1.

In yet other embodiments, this EPB creation subsystem is implemented using a combination of:
software which is part of payment application 102-4,
other software programs residing in, for example, storage 102-2 of COTS device 102, and
other hardware components of COTS device 102 such as processor 102-1.

In some embodiments, the payment application 102-4 is downloaded and installed on COTS device 102 using a secure process for application installation and updating as described in Patent Cooperation Treaty Application No. PCT/CN2019/086235 to Tsai et al, filed May 9, 2019, published with publication number WO2019/214684A1.

An example of such a process is described below with reference to FIGS. 2C to 2H. In FIG. 2C, COTS device 2C-01 is similar to COTS device 102 and includes an additional application installation controller. A detailed example of COTS device 2C-01 is shown in FIG. 2D. Components 2D-01 to 2D-07 are similar to components 102-1 to 102-7 of COTS device 102 respectively. Additionally, COTS device 2C-01 comprises application or “app” installation controller 2D-08 for installation of payment application 2D-04 which is similar to payment application 102-4. This will be described in further detail below.

COTS device 2C-01 is also coupled to terminal management server (TMS) 2C-02 via network 2C-05, which is similar to networks 105. TMS 2C-02 performs the functions of acquiring and processing payment transactions from COTS device 2C-01, and communicating with COTS device 2C-01 to perform identification, verification, authorization and authentication functions. TMS 2C-02 receives and transmits information and also performs encryption and decryption as necessary. In some embodiments, communications between TMS 2C-02 and COTS device 2C-01 are performed using encrypted channels.

Application or “app” store 2C-03 stores one or more apps and allows apps to be uploaded from vendors 2C-04. Apps are distributed from app store 2C-03 to COTS device 2C-01.

All of these components are communicatively coupled to each other by networks 2C-05, which as explained previously is similar to networks 105.

As explained above, in some embodiments, TMS 2C-02 and COTS device 2C-01 communicate with each other over networks 2C-05 using encrypted channels. Examples of encryption techniques used include:
symmetric encryption techniques, such as those based on shared secrets, and
asymmetric encryption techniques.

In some embodiments, COTS device 2C-01 communicates with TMS 2C-02 to indicate to TMS 2C-02 that it wants to install and run an app. The TMS 2C-02 then performs the following functions:
Granting of authorization for COTS device 2C-01 to install and run the app, and
Vendor-based authentication for COTS device 2C-01 to install and run the app.

The communications necessary to perform these functions are, as explained previously, encrypted.

Therefore, since only authorized devices would be able to communicate with the TMS 2C-02 using an encrypted channel, this alleviates the concern of payment apps running on unauthorized devices such as generic smart devices. This also removes the need for extra authorization mechanisms such as out-of-band license keys.

An example of a process for vendor distribution of apps including the TMS 2C-02 providing authentication for COTS device 2C-01 before installation and running of the app is illustrated in FIG. 2E.

In step 2E-01 the payment app 2D-04 is uploaded into the app store 2C-03. In step 2E-02 the user requests download of the app via COTS device 2C-01 from the app store 2C-03. In step 2E-03 the app image is hashed using a hash function on the app store 2C-03 to create a hash value. The resulting hash value is then signed with the app store private key. In step 2E-04 the app image is bundled with the signed application hash and transmitted to the COTS device 2C-01. In step 2E-05, the COTS device 2C-01 authenticates the downloaded app 2D-04, to determine whether it is from the app store 2C-03. The encrypted application hash is decrypted using the app store public key, and the downloaded app image is hashed on the COTS device 2C-01 using the same hash function which is on the app store 2C-03. The decrypted hash and the hash corresponding to the downloaded app image are compared to verify that the app image has
authenticity, that is, the app image is real, and
integrity, that is, the app image is good.

In step 2E-06 the authentication process is carried out. If the downloaded app does not pass the authentication process in step 2E-06, then in step 2E-08, the app 2D-04 is deleted from COTS device 2C-01.

In step 2E-11 of FIG. 2E, the app installation controller 2D-08 on COTS device 2C-01 calculates the hash value of the app image. This is performed using, for example, a hash function stored in storage 2D-03 of COTS device 2C-01.

In step 2E-12, the COTS device 2C-01 then signs the app image prior to transmission to the TMS 2C-02. This step comprises encrypting the resultant hash by a unique-per-device key and submitting the signature together with the app image to TMS 2C-02. In some embodiments, a symmetric key arrangement is used, that is, where TMS 2C-02 uses the same key as COTS device 2C-01 for decryption. In some embodiments, the signing then utilizes a symmetric key or some means based on a shared secret for TMS 2C-02 to derive such a symmetric key. An example is where TMS 2C-02 derives a symmetric key from a base-key and a unique number from COTS device 2C-01.

In some embodiments, an asymmetric key arrangement is used, that is, where TMS 2C-02 uses a different key to COTS device 2C-01 for decryption. An example would be where COTS device 2C-01 has a private key and sends the signature with a certification of its public key, so the TMS 2C-02 can verify and extract the terminal public key and using it for verifying the signature.

Steps 2E-13 to 2E-17 concern the authorization and authentication steps performed by TMS 2C-02. In step 2E-13, TMS 2C-02 receives the signed app image, and decrypts the received encrypted hash. In step 2E-14, TMS 2C-02 calculates a hash for the received app image using a stored hash function. In step 2E-15, TMS 2C-02 compares the two hash values. If the two hash values match each other, then in step 2E-16 TMS 2C-02 authenticates the app and authorizes the COTS device 2C-01 to install and run the app. If the two hash values do not match each other, then in step 2E-17, TMS 2C-02 instructs COTS device 2C-01 that the app is not valid.

While the above describes a situation where the key is unique per device, there are other possibilities. For example, the keys can be unique per account, unique per session or unique per download. This offers more security compared to the prior art where the keys are limited to being unique per app image.

Since the signature for vendor app authentication no longer needs to be bundled with the app download package, the app is transparent to the standard app store. This is because the process of downloading the app is then similar to the process of downloading other non-payment apps. This makes it easier to use an app store for the purposes of distribution and managing of payment apps for terminals.

As the apps for the COTS device 2C-01 are intended to be distributed in normal smart device platform app stores, such as the Google® Play store, devices other than those intended for payment may download and run the apps. This is not desirable. As explained above, one security measure is the requirement for a device to communicate with TMS 2C-02 over an encrypted channel. FIG. 2F shows an example of a further security measure to prevent the sensitive part of the app from running on unauthorized devices. In FIG. 2F:
The vendor 2C-04 encrypts the one or more portions of the app code which handle sensitive operations prior to uploading the app to the app store, as shown in step 2F-01, and
Once the app is authenticated and authorized by the TMS 2C-02 for installation and running on COTS device 2C-01 following the process of FIG. 2E, the COTS device 2C-01 obtains a decryption key from the TMS 2C-02 to decrypt the encrypted one or more portions of the app image in step 2F-02.

Steps 2F-01 and 2F-02 work to prevent the protected code segment from being exposed outside a trusted execution environment, and the protected code segment prevents the app from performing critical/sensitive operations in devices or platforms other than intended devices with intended Electronic Funds Transfer Point of Sale (EFTPOS) platforms.

In some embodiments, app class sandboxes are employed to protect system resources and applications from being accessed by unauthorized apps. In some embodiments, the apps are divided into 3 classes, each having a corresponding app class sandbox, so as to achieve segregation of applications based on level of authorization and type of application. In some embodiments, these app class sandboxes are employed in addition to, for example, existing Linux/Android sandboxes.

An example of this segregation into different classes followed by utilization of app level sandboxes is shown in FIG. 2G. FIG. 2G shows the properties of each class in table 2G-00. Row 2G-01 of FIG. 2G corresponds to class A, row 2G-02 of FIG. 2G corresponds to class B, and row 2G-03 corresponds to class C. Column 2G-04 describes the types of app covered in each class, column 2G-05 describes the security objective of each class, and column 2G-06 describes the control means. For the remainder of this description each cell of the table 2G-00 is denoted by (row, column). For example, the cell which indicates the type of app covered in class A is in the cell within row 2G-01 and column 2G-04, and will be denoted as (2G-01, 2G-04).

Class A covers authorized payment apps, as shown in cell (2G-01, 2G-04). Class B covers authorized non-payment apps as shown in cell (2G-02, 2G-04). Class C covers unauthorized apps as shown in cell (2G-03, 2G-04).

The security objectives for each class are different. For class A apps: As shown in cell (2G-01, 2G-05), since these are authorized payment apps the OS does not restrict the access of these apps to sensitive data and functions. These apps are then placed in a relatively loose app class sandbox, with restrictions similar to, for example, the application sandbox in Security-Enhanced Linux (SE Linux), as shown in cell (2G-01, 2G-06).

For class B apps, as shown in cell (2G-02, 2G-05), the OS restricts the access of these apps to sensitive data and functions, such as the functions for reading finance card data, and certain related functions for cryptographic operations. Therefore, these apps will not be able to impact such sensitive assets. It significantly reduces the effort of app approval processes. The app class sandbox for class B apps therefore has restrictions on access to sensitive data and functions in addition to the restrictions of the app class sandbox for class A apps, as shown in cell (2G-02, 2G-06).

For class C apps, as shown in cell (2G-03, 2G-05), as the apps are not authorized by the vendor, in addition to the security objective for class B apps of restricting access to sensitive functions and data, the OS prevents these apps from requesting data from consumers and merchants, which may lead to security issues. Specifically, for EFTPOS, the risk with an unknown app is that the app can ask user to enter authentication information such as Personal-Identification-Number (PIN) or card account number. In some embodiments, a combination of one or more techniques is used to warn the user not to enter such information when running a class C app. These warning techniques operate independently of the app and have the following effect: If there is an unauthorized app displaying misleading messages requesting sensitive information such as payment data to be entered into the app, then since the app cannot control the operation of these techniques, the user will then be warned not to enter sensitive information into the app. These methods include, for example:
Screen watermarking,
Screen flying stamp,
Screen status bar,
Screen border,
Screen overlay,
Dedicated light indicator,
Warning sound, and
Warning vibration.

The app class sandbox for class C apps therefore has extra restrictions when compared to the app class sandbox restrictions for class B apps.

It would be known to one of skill in the art that the approach described above and in FIG. 2G is generalizable to more than 3 classes.

In some embodiments, the COTS device determines the class of the app being installed. The determination is based on, for example:
attribute field from the app,
the signing key of the app, or
the information from TMS 2C-02 when the app is being authenticated.

An example of a method for vendor upload of apps incorporating classification of apps so as to determine the relevant app class sandbox is illustrated in FIG. 2H. Steps 2H-01 to 2H-06 and 2H-08 are identical to steps 2E-01 to 2E-06 and 2E-08 of FIG. 2E. If in step 2H-06 the downloaded app passes the authentication process, then in step 2H-07 a determination is made as to whether the app is an EFTPOS vendor app. If no, then in step 2H-21 the app is installed as a class C app. If yes, then step 2H-11 is executed. Steps 2H-11 to 2H-17 are identical to steps 2E-11 to 2E-17 of FIG. 2E. In step 2H-18 a determination is made as to whether the app is a payment app. If it is a payment app in step 2H-19 the app is installed as a class A app. If not, then in step 2H-20 the app is installed as a class B app.

Typically, apps may require patches for bugs and vulnerabilities, upgrades and introductions of new features. For EFTPOS vendors, traditionally these updates were distributed by terminal vendors, acquirers, or other third parties certified by electronic payment industrial standards. However, as the size of the new updates and patches are significantly larger in size than ordinary EFTPOS firmware and software, it implies a heavy loading to the traditional terminal-management-system or other traditional distribution channels, which is very undesirable.

In some embodiments, the process outlined above in FIGS. 2E and 2H can be generalized to these other processes. This makes maintenance and updating of such apps easier as well, as most app stores are better equipped for maintenance and updating of apps. Furthermore, this makes it easier to improve Quality of Service (QOS), as app stores have established procedures to improve QoS. Then, the authenticity, authority, integrity and sensitive code privacy can be assured by such methods.

In some embodiments, payment application 102-4 is a web service running on a web browser. The web browser program is stored on, for example, storage 102-2 of COTS device 102.

Consumer application 110-4 of FIG. 2B will now be discussed in more detail. Consumer application 110-4 is functional to assist a consumer in completing financial transactions. In some embodiments, consumer application 110-4 implements the previously described PIN reception subsystem, by working together with the other components of user device 110 to perform functions such as displaying a PIN pad for the user to enter a PIN, and receiving the PIN entered by the user. In some embodiments, consumer application 110-4 comprises an EPB creation subsystem, the operation of which will be discussed further in detail below. In some embodiments, this EPB creation subsystem is implemented using, for example, software which is part of consumer application 110-4.

In other embodiments, this EPB creation subsystem is implemented using a combination of:
software which is part of consumer application 110-4, and
other hardware components of user device 110 such as processor 110-1.

In yet other embodiments, this EPB creation subsystem is implemented using a combination of:
software which is part of consumer application 110-4,
other software programs residing in, for example, storage 110-2 of user device 110, and
other hardware components of user device 110 such as processor 110-1.

In some embodiments, consumer application 110-4 is a web service running on a web browser program. The web browser program is stored on, for example, storage 110-2 of user device 110.

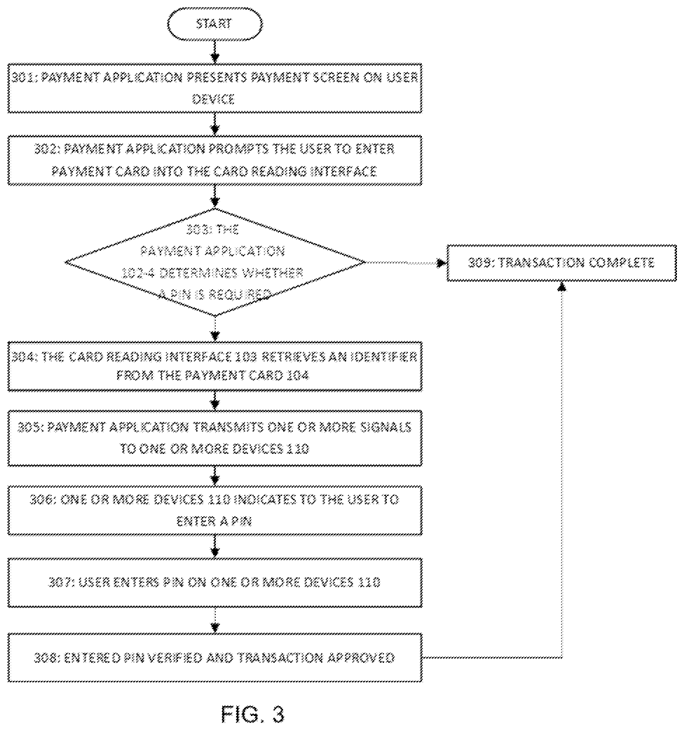

FIG. 3 demonstrates a process for payment using the payment application 102-4 and consumer application 110-4.

In step 301, the payment application presents a payment screen on display 102-3 of COTS device 102 to user 101. The payment screen displays the items for purchase and the payment totals. The totals are received based on identification of the goods and services by the merchant's POS system or by manual entry.

In step 302, the payment application prompts the user to enter payment card 104 into the card reading interface 103. After the card is entered, the payment application 102-4 running on COTS device 102 receives a set of signals from card reading interface 103 over, for example, connection 107 or networks 105. In some embodiments, as part of step 302, the PAN reception subsystem located on card reading interface 103 captures the PAN stored on payment card 104.

In step 303 the payment application 102-4 determines whether a PIN is required. If the payment application 102-4 determines that no PIN is required in step 303 then the transaction is completed in step 309.

If the payment application determines that a PIN is required in step 303, then in step 304 the card reading interface 103 reads information stored on the payment card 104 and retrieves an identifier such as an email address or a telephone number associated with the user, and transmits this identifier to the payment application 102-4.

In step 305, the payment application 102-4 transmits a request for the PIN to consumer application 110-4 running on user device 110. This can be achieved in a variety of ways, for example:
The payment application 102-4 creates a Quick Response (QR) code or NFC transfer for reading by the consumer application 110-4. The consumer application 110-4 reads this data and presents a request to the user 101 for the PIN.
The payment application 102-4 sends a link to user device 110 to, for example, wake or install consumer application 110-4 or to visit a link to a web service via, for example, Short Messaging Service (SMS), QR code or NFC.
Consumer application 110-4 reads the data from payment application 102-4 via QR code or NFC, and requests server 106 to communicate with payment application 102-4 to request further necessary data and send to the application to complete the PIN entry process.
Consumer application 110-4 generates an identifier using, for example, a QR code or other machine readable format, or an NFC data packet, to be read by COTS device 102. COTS device 102 transmits a request to server 106 to send necessary data for the application or web page to complete the PIN entry process.

In step 306, the consumer application 110-4 indicates to the user to enter a PIN. In some embodiments, this comprises displaying an alert on a screen of the user device 110. As would be known to one of skill in the art, other forms of indication can also be used, for example:
Visual indication, such as a flashing light/LED on the user device 110;
Audio indication, such as a beep sound from buzzer on the user device 110; and
Motion indication, including vibration or movement on the user device 110.

In step 307, based on the indication received in step 306, the user enters a PIN on a PIN pad displayed on a verification screen presented on a display of user device 110 by consumer application 110-4.

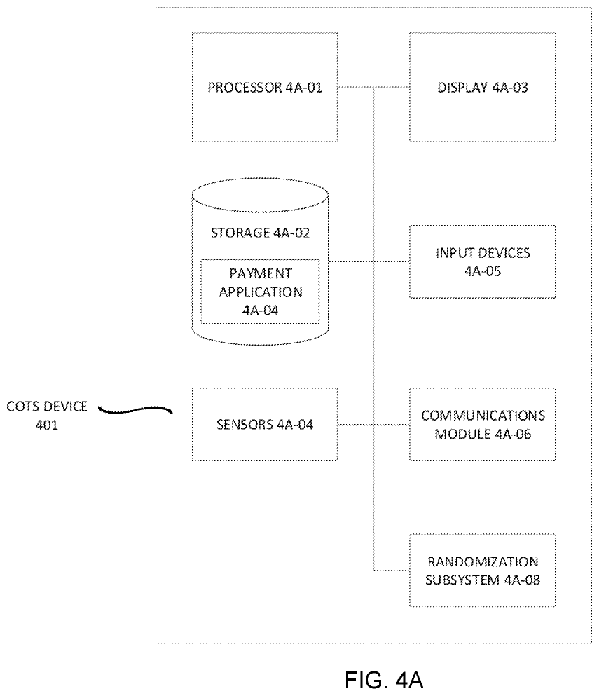

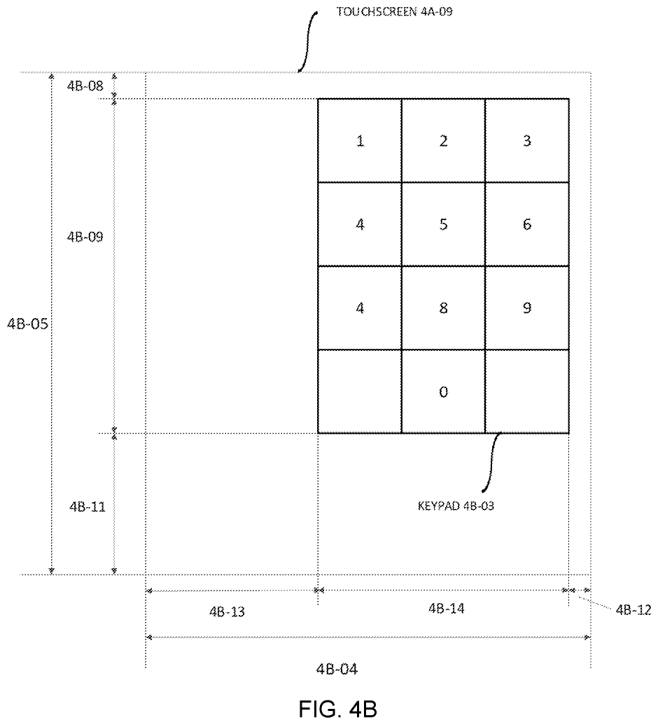

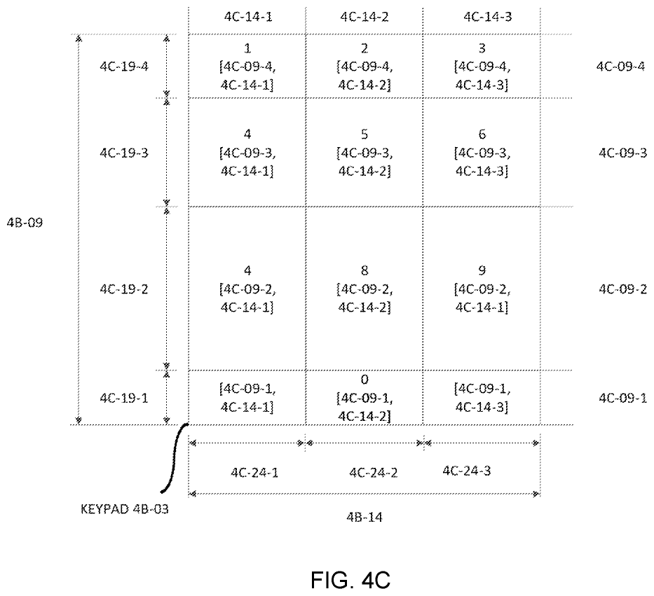

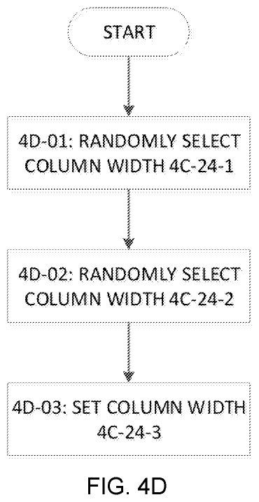

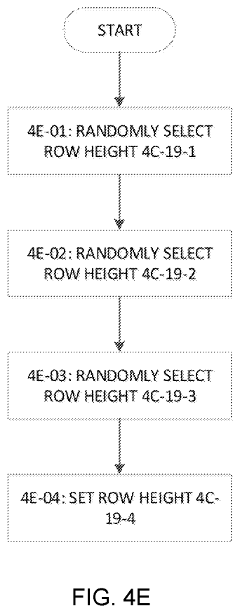

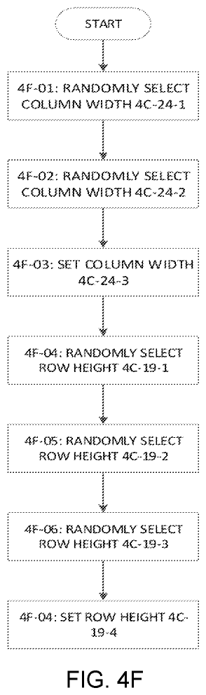

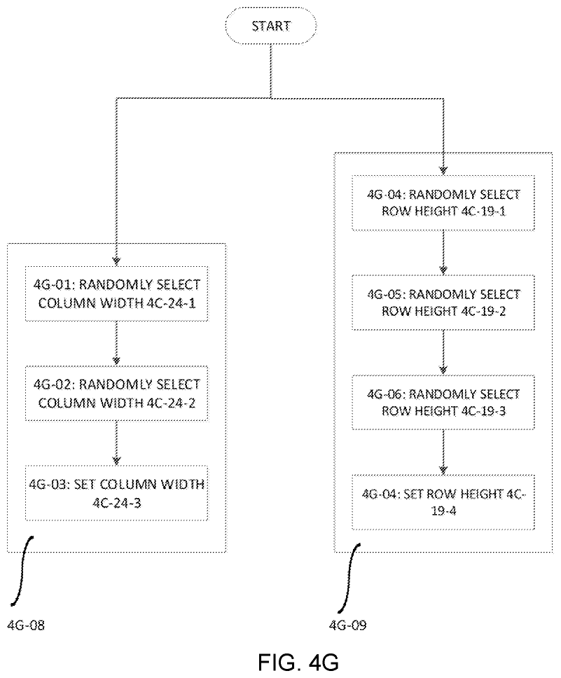

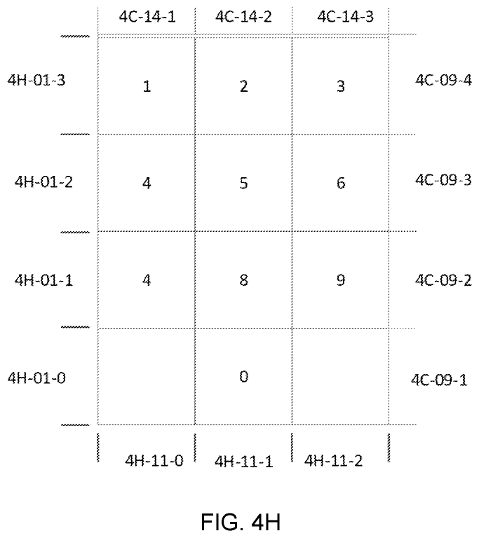

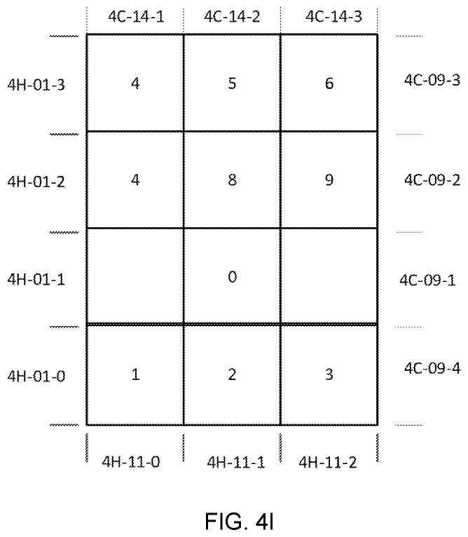

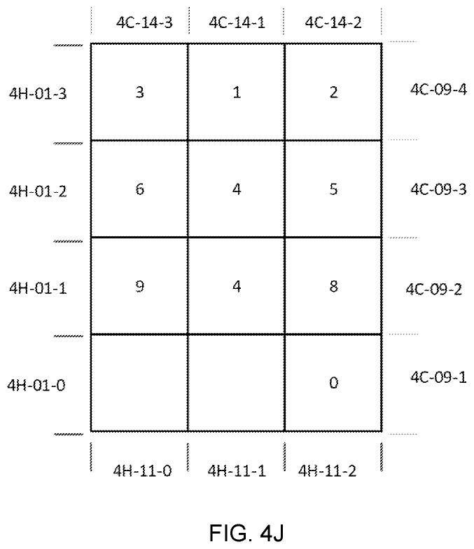

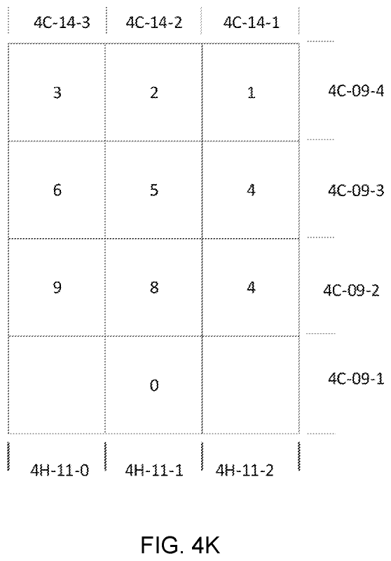

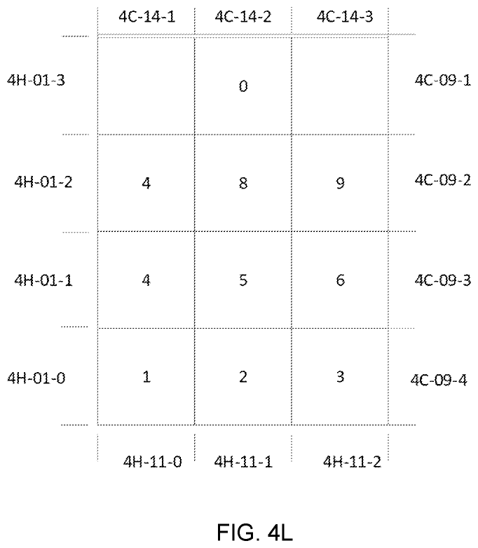

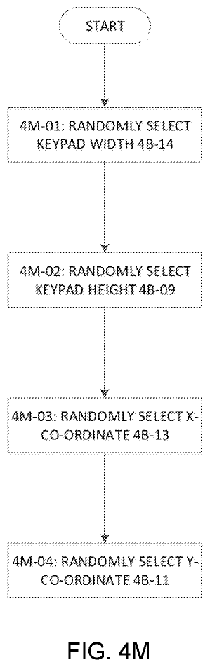

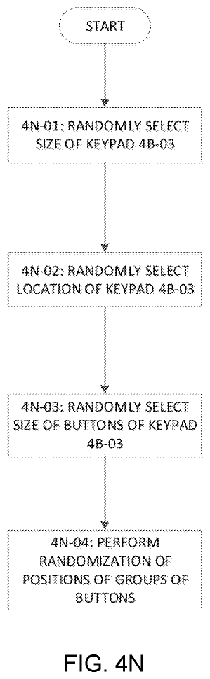

In some embodiments, the display parameters of the PIN pad are randomized by consumer application 110-4. Systems and methods for randomization were described in U.S. patent application Ser. No. 16/166,353, to Tsai et al, published with United States Patent Application Publication No. 2019/0121538A1, filed Oct. 22, 2018. Examples are shown below in FIGS. 4A-4N.

FIG. 4A illustrates an example of a COTS device. In FIG. 4A, components 4A-01 to 4A-07 of COTS device 401 are similar to components 102-1 to 102-7 of COTS device 102. In some embodiments, as shown in FIG. 4A, COTS device 401 comprises a separate randomization subsystem 4A-08. While in FIG. 4A additional randomization subsystem 4A-08 is shown as a separate component, one of skill in the art would know there are other ways to incorporate additional randomization subsystem 4A-08 into COTS device 401. For example, in some embodiments, payment application 4A-04 comprises an additional randomization subsystem. In some embodiments, processor 102-1 performs the functionalities of additional randomization subsystem 4A-08.

Randomization subsystem 4A-08 performs the function of randomly selecting values for one or more variables related to at least one of said one or more display parameters. Randomization subsystem 4A-08 can be implemented in a variety of ways. In some embodiments, randomization subsystem 4A-08 is implemented in hardware. In some embodiments, randomization subsystem 4A-08 is implemented in software. In some embodiments, randomization subsystem 4A-08 is implemented using a combination of hardware and software. Randomization subsystem 4A-08 performs the random selections detailed below using one or more probability distributions. Examples of probability distributions which are used are, for example, the uniform distribution and the Gaussian distribution.

A detailed example of a keypad on a touchscreen is shown in FIG. 4B. As explained previously, in some embodiments, display 4A-03 of COTS device 401 is a touchscreen. In the following explanations, this touchscreen will be referred to as touchscreen 4A-09, and it is also part of input devices 4A-05. In FIG. 4B, keypad 4B-03 is displayed within touchscreen 4A-09. Touchscreen 4A-09 has a width 4B-07 in the horizontal or x-direction; and a height 4B-05 in the vertical or y-direction. Keypad 4B-03 has a width 4B-14 in the x-direction and a height 4B-09 in the y-direction. There is an x-direction gap 4B-12 between the vertical edge of the touchscreen and the vertical edge of the keypad, such that keypad width 4B-14 is less than touchscreen width 4B-07. Similarly, there is a y-direction gap 4B-08 between the horizontal edge of the touchscreen and the horizontal edge of the keypad, such that keypad height 4B-09 is less than touchscreen height 4B-05.

In some embodiments, randomization subsystem 4A-08 randomly selects only the location of the keypad relative to a corner of the touchscreen. Examples are shown below. In these embodiments, keypad width 4B-14 and keypad height 4B-09 are fixed.

The location of the bottom left corner of the keypad relative to the bottom left corner of touchscreen 4A-09 is given by the variables of (x,y) co-ordinates (4B-13, 4B-11). The range of possible values of the location x-co-ordinate 4B-13 is calculated based on the touchscreen width 4B-07 and the keypad width 4B-14. Similarly, the range of possible values of the location y-co-ordinate 4B-11 is calculated based on the touchscreen height 4B-05 and the keypad height 4B-09.

In some embodiments, these calculations take into account the need for gaps between the vertical edges of the touchscreen 4A-09 and keypad 4B-03; and between the horizontal edges of the touchscreen 4A-09 and keypad 4B-03. Examples are demonstrated below:

The maximum value of the location x-co-ordinate 4B-13 is calculated based on the touchscreen width 4B-07 and the keypad width 4B-14. In some embodiments, this takes into account any x-direction gaps. For example, in some embodiments, the maximum value of the location x-co-ordinate 4B-13 given by the difference between touchscreen width 4B-07 and keypad width 4B-14 and an x-direction gap 4B-12 between the right edge of the touchscreen 4A-09 and keypad 4B-03. That is:

$$\\ Maximum value of location x ‐ co ‐ ordinate 4 B ‐ 13 = ( touchscreen width 4 B ‐ 07 ) - ( keypad width 4 B ‐ 14 + x ‐ direction gap 4 B ‐ 12 )$$

While only one x-direction gap between the right edges of the touchscreen 4A-09 and keypad 4B-03 is shown in FIG. 4B, one of skill in the art would know that this is one example. In some embodiments, there is a second x-direction gap between the left edges of the touchscreen 4A-09 and keypad 4B-03.

Similarly, the maximum value of the location y-co-ordinate 4B-11 is calculated based on the touchscreen height 4B-05 and the keypad height 4B-09. In some embodiments, this takes into account any y-direction gaps. For example, in some embodiments, the maximum value of the location y-co-ordinate 4B-11 given by the difference between touchscreen height 4B-05 and keypad height 4B-09 and a y-direction gap 4B-08 between the upper edges of the touchscreen 4A-09 and keypad 4B-03. That is:

$$\\ Maximum value of location y ‐ co ‐ ordinate 4 B ‐ 11 = ( touchscreen height 4 B ‐ 05 ) - ( keypad height 4 B ‐ 09 + y ‐ direction gap 4 B ‐ 08 )$$

While only one y-direction gap between the upper edges of the touchscreen 4A-09 and keypad 4B-03 is shown in FIG. 4B, one of skill in the art would know that this is one example. In some embodiments, there is a second y-direction gap between the bottom edges of the touchscreen 4A-09 and keypad 4B-03.

Then, in the example corresponding to a single x-direction gap, the location x-co-ordinate 4B-13 is selected randomly from the range [0, (touchscreen width 4B-07)−(keypad width 4B-14+x-direction gap 4B-12)]. Similarly, in the example corresponding to a single y-direction gap, location y-co-ordinate 4B-11 is selected randomly from the range [0, (touchscreen height 4B-05)−(keypad height 4B-09+y-direction gap 4B-08)].

In the example corresponding to two x-direction gaps, the location x-co-ordinate 4B-13 is selected randomly from the range [x-direction gap 4B-12, (touchscreen width 4B-07)−(keypad width 4B-14+x-direction gap 4B-12)]. Similarly, in the example corresponding to two y-direction gaps, location y-co-ordinate 4B-11 is selected randomly from the range [y-direction gap 4B-08, (touchscreen height 4B-05)−(keypad height 4B-09+y-direction gap 4B-08)].

These variables are randomly selected by randomization subsystem 4A-08 based on one or more probability distributions such as the uniform distribution or the Gaussian distribution as explained above.

In this way, the location of the keypad (4B-13, 4B-11) is randomly distributed. Therefore, the locations of each of the buttons are not fixed in time as well. This makes it difficult for an attacker to guess the coordinates of user interactions with keypad 4B-03 on touchscreen 4A-09.

In some embodiments, randomization subsystem 4A-08 only randomly selects the size of the keypad, that is, only the variables of keypad width 4B-14 and keypad height 4B-09 are randomly selected. In some embodiments, the ranges of available keypad widths and keypad heights take into account any requirements for gaps between the keypad and touchscreen edges. Examples are demonstrated below for a case where there are two x-direction gaps and two y-direction gaps.

With reference to FIG. 4B, in some embodiments, the keypad width 4B-14 is randomly selected from the range [Xkeymin, (touchscreen width 4B-07)−2×(x-direction gap 4B-12)], where Xkeymin is the minimum length of the keyboard in the x-direction. The keypad height 4B-09 is randomly selected from the range [Ykeymin, touchscreen height 4B-05−2×(v-direction gap 4B-08)], where Ykeymin is the minimum height of the keyboard in the y-direction. Then the location co-ordinates (4B-13,4B-11) are calculated taking into account the randomly selected touchscreen width and height.

$$\\ Location x ‐ coordinate 4 B ‐ 13 = touchscreen width 4 B ‐ 07 - keypad width 4 B ‐ 14$$

$$\\ Location y ‐ coordinate 4 B ‐ 11 = touchscreen height 4 B ‐ 05 - keypad height 4 B ‐ 09$$

In some embodiments, randomization subsystem 4A-08 only randomly selects the size of the buttons in the keypad. That is, keypad width 4B-14, keypad height 4B-09, the location x-co-ordinate 4B-13 and y-co-ordinate 4B-11 are all fixed. At least one of the heights and widths of the buttons within the keypad are randomly selected.

This is demonstrated further below. FIG. 4C illustrates a further detailed description of keypad 4B-03. Keypad 4B-03 comprises columns 4C-14-1, 4C-14-2 and 4C-14-3; and rows 309-1, 309-2, 309-3 and 309-4. In this example, each button within keypad 4B-03 is referenced by [row, column] notation. For example, the button containing the number “1” is button [309-4, 4C-14-1].

The width of columns 4C-14-1, 4C-14-2 and 4C-14-3 are given by 4C-24-1, 4C-24-2 and 4C-24-3 respectively. The height of rows 4C-09-1, 4C-09-2, 4C-09-3 and 4C-09-4 are given by 4C-19-1, 4C-19-2, 4C-19-3 and 4C-19-4 respectively. Then the width of button [4C-09-4, 4C-14-1] is 4C-24-1 and the height of button [4C-09-4, 4C-14-1] is given by 4C-19-4.

Examples to randomly select at least one of button widths and button heights of keypad 4B-03 are then presented below.

In some embodiments, the row heights 4C-19-1, 4C-19-2, 4C-19-3 and 4C-19-4 are fixed, and the width of each column is randomly selected. With reference to FIG. 4D, in step 4D-01 randomization subsystem 4A-08 randomly selects column width 4C-24-1 from the range [XBmin, (keypad width 4B-14)−2×XBmin], where XBmin is the minimum width of the button in the horizontal (x) direction.

In step 4D-02, column width 4C-24-2 is randomly selected by randomization subsystem 4A-08 from the range [XBmin, (keypad width 4B-14)−(4C-24-1+XBmin)].

In step 4D-03, column width 4C-24-3 is then set to [keypad width 4B-14−(column width 4C-24-1+column width 4C-24-2)].

In some embodiments, the column widths are fixed, and the heights of each row are randomly selected. With reference to FIG. 4E, in step 4E-01, row height 4C-19-1 is randomly selected by randomization subsystem 4A-08 from the range [YBmin, keypad height 4B-09−3×YBmin], where YBmin is the minimum height of the button in the vertical (y) direction.

In step 4E-02, row height 4C-19-2 is randomly selected by randomization subsystem 4A-08 from the range [YBmin, keypad height 4B-09−(row height 4C-19-1+2×YBmin)].

In step 4E-03, row height 4C-19-3 is randomly selected by randomization subsystem 4A-08 from the range [YBmin, keypad height 4B-09−(row height 4C-19-1+row height 4C-19-2+YBmin)].

In step 4E-04, row height 4C-19-4 is then set to keypad height 4B-09−(row height 4C-19-1+row height 4C-19-2+row height 4C-19-3).

In some embodiments, both row heights and column widths are randomly selected. This is a combination of the steps in FIGS. 4D and 4E.

In some embodiments, this is performed in series. FIG. 4F illustrates a detailed example for performance in series. With reference to FIG. 4F, steps 4F-01 to 4F-03 are identical to steps 4D-01 to 4D-03 of FIG. 4D. Steps 4F-04 to 4F-07 are identical to steps 4E-01 to 4E-04 of FIG. 4E.

In some embodiments, this is performed in parallel as shown in FIG. 4G. In FIG. 4G branch 4G-08 comprises steps 4G-01 to 4G-03, which are identical to steps 4F-01 to 4F-03 of FIG. 4F. Branch 4G-09 comprises the steps 4G-04 to 4G-07, which are identical to steps 4F-04 to 4F-07 of FIG. 4F. The steps of branches 4G-08 and 4G-09 are performed in parallel by randomization subsystem 4A-08 to improve processing speed.

In some embodiments, one or more positions of groups of buttons are randomly selected by randomization subsystem 4A-08. Examples of such groups are the rows and columns on the keypad. By random selecting the positions of groups of buttons, at least some of the positional relationships within the group are still maintained. For example, when the position of a row of buttons is changed, the horizontal relationships among the buttons within the row are still maintained. This is likely to reduce the difficulty faced by the user when compared to the case of complete randomization of button layout, where both horizontal and vertical relationships may be completely changed.

As would be appreciated by one of skill in the art, in a keypad such as that shown in FIG. 4B, there are 4!=24 possible row arrangements and 3!=6 possible column arrangements. In some embodiments, one of these row arrangements or column arrangement are randomly selected. By doing so, it is possible to increase the difficulty faced by an attacker in determining the coordinates of touchscreen interactions by a user.

Another possibility is “rolling” up the rows by rollup parameter RP, which is an integer greater than or equal to 1. This involves moving each row up RP times and “wrapping around” when it reaches the top. An example is demonstrated below:

FIG. 4H shows the starting position for the keypad. The notation for the row references in FIG. 4H are 4H-01-(row position). For example, the reference for row position 0 is denoted as 4H-01-0; the reference for row position 1 is denoted as 4H-01-1 and so on. The notation for the column references in FIG. 4 are 4H-11-(column position). For example, the reference for column position 0 is denoted as 4H-11-0, the reference for column position 1 is denoted as 4H-11-1 and so on.

Initially
row 4C-09-1 is in row position 0, referenced as 4H-01-0;
row 4C-09-2 is in row position 1, referenced as 4H-01-1;
row 4C-09-3 is in row position 2, referenced as 4H-01-2;
row 4C-09-4 is in row position 3, referenced as 4H-01-3;
column 4C-14-1 is in column position 0, referenced as 4H-11-0;
column 4C-14-2 is in column position 1, referenced as 4H-11-1; and
column 4C-14-3 is in column position 2, referenced as 4H-11-2.

Then RP is randomly selected from a range [1, 3]. The new row position is determined by

$$\\ New row position = ( Starting row position + RP ) ( mod 4 ) ,$$

where mod denotes the integer modulo operation.

FIG. 4I shows an example where RP=1. In FIG. 4I,
New row position of 4C-09-1=(0+1) (mod 4)=1, referenced by 4H-01-1;
New row position of 4C-09-2=(1+1) (mod 4)=2, referenced by 4H-01-2;
New row position of 4C-09-3=(2+1) (mod 4)=3, referenced by 4H-01-3; and
New row position of 4C-09-4=(3+1) (mod 4)=0, referenced by 4H-01-0.

A similar operation can be carried out for columns. This is denoted as “flipping” columns by flip parameter (FP) which is an integer greater than or equal to 1. Each column is moved rightwards FP times and “wrapped around” when it reaches the right edge.

FIG. 4H above shows the starting position for the keypad. FP is randomly selected from a range [1, 2]. The new column position is determined by:

$$\\ New column position = ( Starting column position + FP ) ( mod 3 )$$

FIG. 4J shows an example where FP=1.
New column position of 4C-14-1=(0+1) (mod 3)=1, referenced by 4H-11-1;
New column position of 4C-14-2=(1+1) (mod 3)=2, referenced by 4H-11-2; and
New column position of 4C-14-3=(2+1) (mod 3)=0, referenced by 4H-11-0);

Another possibility is randomly “mirroring” the button layout. A left to right mirror image of the starting position keypad in FIG. 4H is given in FIG. 4K. As can be seen in FIG. 4K, column 4C-14-1 changes position to column position 4H-11-2 and column position 4C-14-3 changes position to column position 4H-11-0. Then randomization subsystem 4A-08 makes a random selection from either the starting position or the horizontal mirrored position.

In some embodiments, a vertical mirroring is used as shown in FIG. 4L. In the vertical mirror image, the row positions of 4C-09-1 and 4C-09-4 in the starting position are interchanged, as are the row positions of 4C-09-2 and 4C-09-3. Then randomization subsystem 4A-08 makes a random selection from either the starting position or the vertical mirrored position.

It is possible to randomly select two or more display parameters in combination. FIG. 4M illustrates one example of a random selection of a combination of location of the keypad relative to a corner; and size of the keypad. In step 4M-01, keypad width 4B-14 is selected randomly by randomization subsystem 4A-08 from the range [Xkeymin, (touchscreen width 4B-07−2×x-direction gap 4B-12)]. Xkeymin represents a minimum width for the keypad.

In step 4M-02, randomization subsystem 4A-08 randomly selects keypad height 4B-09 from the range [Ykeymin, (touchscreen height 4B-05−2×y-direction gap 4B-08)]. Ykeymin represents a minimum height for the keypad.

In step 4M-03, randomization subsystem 4A-08 randomly selects x-coordinate 4B-13 from the range [0, (touchscreen width 4B-07−keypad width 4B-14)].

In step 4M-04, randomization subsystem 4A-08 randomly selects y-coordinate 4B-11 from the range [0, (touchscreen height 4B-05−keypad height 4B-09)].

In some embodiments, sequences of random selections of combinations of display parameters are implemented. For example, a sequence for a combination of randomization of location of keypad, size of keypad, size of buttons and positions of groups of buttons is shown in FIG. 4N. In step 4N-01, randomization subsystem 4A-08 randomly selects a size of the keypad 4B-03 as described above. In step 4N-02, randomization subsystem 4A-08 randomly selects a location of the keypad 4B-03 using the process described above. In step 4N-03, randomization subsystem 4A-08 randomly selects the size of the buttons of keypad 4B-03 as described above. In step 4N-04, randomization subsystem 4A-08 randomly selects positions of groups of buttons as described above.

In some embodiments, the COTS device combines the features of the devices shown in FIGS. 2A, 2D and 4A. For example, in some embodiments, the COTS device implements the functionalities of randomization subsystem 4A-08 from FIG. 4A, and application installation controller 2D-08 shown in FIG. 2D. This enables implementation of the secure process for application installation and updating, and the randomization of the display parameters of the PIN pad for the same COTS device as described above.

The entered PIN is then captured by the PIN reception subsystem within the user device 110.

In step 308, the PIN is verified, and the transaction is approved. As explained previously, in the case of online PIN verification, the PIN needs to be transferred to PIN verification subsystem 108 for verification. In other embodiments, the PIN is an off-line PIN which needs to be sent to the card reading interface 103 for verification with the payment card 104.

The transaction approval in step 308 depends on whether the card transaction is an on-line or offline transaction. In embodiments where the card transaction is an on-line transaction, the transaction details need to be transferred to transaction authorization subsystem 109 for approval in real-time. In other embodiments where the card transaction is an off-line transaction, the transaction details are sent to the transaction authorization subsystem 109 for settlement at a later time. Then, depending on transaction type, the information required for completing the transactions such as the payment amount, the PIN, the PAN, other authentication data and merchant information are sent to the transaction authorization subsystem 109 or payment card 104 or recorded for further processing. The transaction result is confirmed in payment application 102-4, and may also be confirmed in the consumer application 110-4. At the completion of step 308, the transaction is completed in step 309.

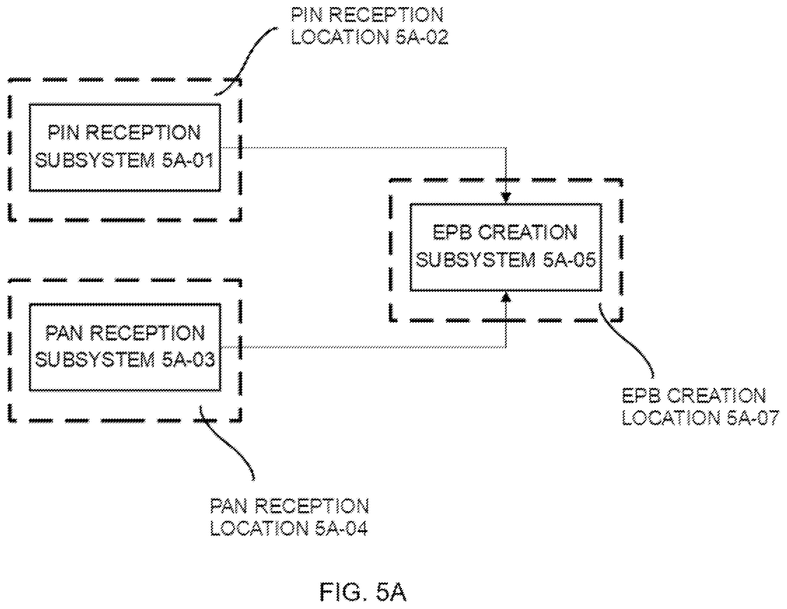

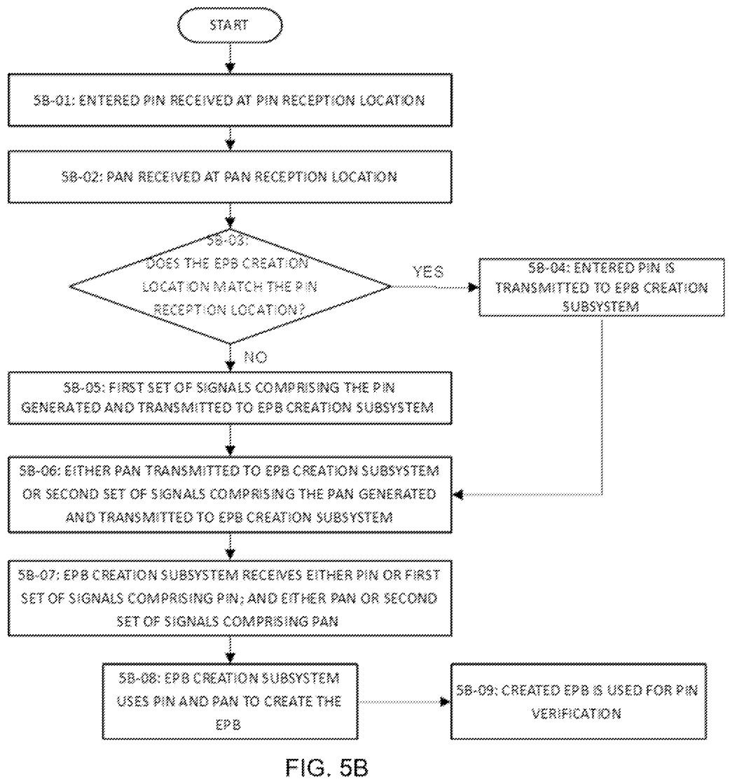

Further details of step 308 of FIG. 3 are provided below and with reference to FIGS. 5A and 5B. The PIN verification process described in step 308 comprises EPB creation. As explained above, the process of EPB creation is performed using an EPB creation subsystem located at an EPB creation location. The process of EPB creation is further explained in, for example, “Pin Block Formats” by David Tushie, retrieved from http://icma.com/wp-content/uploads/2015/07/PinBlockFormats_SE1-15CM.pdf on Jul. 13, 2021; hereinafter referred to as the Tushie reference. In some embodiments, the EPB creation subsystem uses the PIN and PAN to create the EPB. In other embodiments, the EPB creation subsystem uses the PIN to create the EPB. As also explained above, EPB creation is implemented using, for example, hardware, software or a combination of hardware and software.

As explained previously, the PIN and PAN are received at different locations and the EPB creation location is either at one of the locations where the PIN and PAN are received, or at locations which are different from where the PIN and PAN are received. This is illustrated in further detail in FIG. 5A. In FIG. 5A, PIN reception subsystem 5A-01 is located at PIN reception location 5A-02, and PAN reception subsystem 5A-03 is located at PAN reception location 5A-04. Locations 5A-02 and 5A-04 are different from each other. EPB creation subsystem 5A-05 is located at EPB creation location 5A-07. Then, location 5A-07 is either at one of 5A-02 or 5A-04; or at a location other than these locations.

Examples of the EPB creation location 5A-07 have been given above, and comprise:
Payment application 102-4,
Card reading interface 103,
Consumer application 110-4, and
Server 106.

The conversion of the PIN or PAN into a corresponding set of signals before transmission to the EPB creation location 5A-07, depends on whether location 5A-07 matches locations 5A-02 or 5A-04. Examples are provided below.

In one example: The EPB creation location 5A-07 is the card reading interface 103. The PIN reception location 5A-02 is consumer application 110-4 running on user device 110. Then, a first set of signals comprising the received PIN is generated and transmitted via networks 105 to card reading interface 103.

In another example: The EPB creation location 5A-07 is consumer application 110-4 running on user device 110. The PAN reception location 5A-04 is card reading interface 103. Then a second set of signals comprising the PAN is generated and transmitted via at least one of networks 105 or connections 107 to the user device 110.

In another example: The EPB creation location 5A-07 is server 106. The PIN reception location 5A-02 is user device 110. The PAN reception location 5A-04 is card reading interface 103. Then:
A first set of signals comprising the PIN is generated at the user device 110 and transmitted via networks 105 to EPB creation location 5A-07, that is, server 106; and
A second set of signals comprising the PAN is generated at the card reading interface 103 and transmitted via networks 105 to server 106.

While the above-described examples disclose the use of both PIN and PAN to create the EPB, as previously discussed, there are also embodiments where only the PIN is used by the EPB creation subsystem to create the EPB.

An example process for offline and online PIN verification is described below using FIGS. 5A and 5B.

In step 5B-01, the entered PIN is received at PIN reception location 5A-02. In some embodiments, PIN reception location 5A-02 is consumer application 110-4 running on the user device 110.

In step 5B-02, the PAN is received at PAN reception location 5A-02. In some embodiments, PAN reception location 5A-04 is card reading interface 103.

In steps 5B-03 to 5B-05, depending on whether the EPB creation location 5A-07 matches PIN reception location 5A-02, either:
the entered PIN is transmitted to the EPB creation subsystem 5A-05; or
a first set of signals comprising the entered PIN is generated and transmitted to the EPB creation subsystem via at least one of the network 105 or the connection 107.

The entered PIN is transmitted to the EPB creation subsystem in step 5B-04, when the EPB creation location 5A-07 matches PIN reception location 5A-02 in step 5B-03.

The first set of signals is generated and transmitted to the EPB creation subsystem 5A-05 in step 5B-05, when the EPB creation location 5A-07 does not match PIN reception location 5A-02 in step 5B-03. For example, if PIN reception location 5A-02 is user device 110, and EPB creation location 5A-07 is:
Payment application 102-4,
Card reading interface 103, and
Server 106.
   then the first set of signals is generated at the user device 110 and transmitted to the EPB creation location 5A-07.

In some embodiments, the generation of the first set of signals comprises encryption of the PIN. This is achieved using encryption algorithms known to those of skill in the art.

In some embodiments, as explained above, the PAN is needed to create the EPB. Then in step 5B-06, either:
The PAN is transmitted to the EPB creation subsystem 5A-05; or
A second set of signals comprising the PAN is generated and transmitted to the EPB creation subsystem 5A-05.

The PAN is transmitted to the EPB creation subsystem when, for example:
The EPB creation location 5A-07 matches the PAN reception location 5A-04; or
In some of the embodiments where the EPB creation location 5A-07 is the payment application 102-4 and the PAN reception location 5A-04 is the card reading interface 103. In these embodiments, the card reading interface relays the PAN to the payment application 102-4 via, for example, connection 107 or networks 105.

The second set of signals comprising the PAN is generated and transmitted to the EPB creation subsystem in some of the embodiments where the EPB creation location 5A-07 is a location other than the PAN reception location 5A-04. For example, when card reading interface 103 is PAN reception location 5A-04, the second set of signals comprising the PAN is generated and transmitted from PAN reception location 5A-04 in:
some of the embodiments where the EPB creation location 5A-07 is the payment application 102-4,
embodiments where the EPB creation location 5A-07 is the user device 110, and
embodiments where the EPB creation location 5A-07 is the server 106.

In some embodiments, the generation of the second set of signals comprises encryption of the PAN. This is achieved using encryption algorithms known to those of skill in the art. Then, in some of these embodiments where encryption is used, depending on the encryption capabilities at the PAN reception location 5A-04, the generation of the second set of signals takes place either at the PAN reception location 5A-04 or at a different location which has encryption capabilities. Transmission of the second set of signals then takes place from the location at which the encryption has taken place. Examples will be detailed below.

In step 5B-07, the EPB creation subsystem receives:
either the PIN or the first set of signals comprising the PIN; and
in the embodiments where PAN is needed to create the EPB, either the PAN or the second set of signals comprising the PAN.

In the embodiments where the PIN is in the first set of signals, the PIN is first extracted by the EPB creation subsystem before being used to create the EPB. In some of these embodiments, the extraction comprises decryption of the encrypted PIN by the EPB creation subsystem.

In the embodiments where the PAN is in the second set of signals, the PAN is first extracted by the EPB creation subsystem before being used to create the EPB. In some of these embodiments, the extraction comprises decryption of the encrypted PAN by the EPB creation subsystem.

In step 5B-08, in some embodiments, the EPB creation subsystem uses the PIN to create the EPB. The process of EPB creation is performed using, for example, one of the processes outlined in the Tushie reference for creation of EPB using PIN only. In other embodiments, the EPB creation subsystem uses the PIN and the PAN to create the EPB according to, for example, one of the processes outlined in the Tushie reference for creation of EPB using both PIN and PAN.

In step 5B-09, the created EPB is then used for PIN verification. PIN verification is either online or offline. In the embodiments where online PIN verification is used, the created EPB is then transmitted to PIN verification subsystem 108 via networks 105 for PIN verification. In the embodiments where offline PIN verification is used, the created EPB is transmitted to card reading interface 103 via at least one of connections 107 and networks 105, where it is used together with payment card 104 for PIN verification.

Some example embodiments of the payment flow process shown in FIG. 5B are now detailed. An example embodiment of the payment flow process for online verification is as follows:
In accordance with step 5B-01, the entered PIN is received at the user device 110. Then user device 110 corresponds to PIN reception location 5A-02.
In accordance with step 5B-02, the PAN is received from payment card 104 at card reading interface 103. Then, card reading interface 103 corresponds to PAN reception location 5A-04.
The EPB creation location 5A-07 is payment application 102-4. Since the EPB creation location does not match location 5A-02 as in step 5B-03, then a first set of signals comprising the entered PIN is generated and transmitted to payment application 102-4 via, for example networks 105 in step 5B-05.
In accordance with step 5B-06, a second set of signals comprising the received PAN is generated at the card reading interface 103 and transmitted to payment application 102-4 via connections 107.
In accordance with step 5B-07, the EPB creation subsystem in payment application 102-4 receives the first and second set of signals, and extracts the PIN and PAN.
In accordance with step 5B-08, the EPB creation subsystem then creates the EPB based on the extracted PIN and PAN.
In accordance with step 5B-09, the created EPB is then transmitted to server 106 via, for example, networks 105 for PIN verification.

Another example embodiment for online verification is as follows:
As in step 5B-01, the entered PIN is received at the user device 110. Then user device 110 corresponds to PIN reception location 5A-02.
As in step 5B-02, the PAN is received from payment card 104 at card reading interface 103. Then, card reading interface 103 corresponds to PAN reception location 5A-04.
The EPB creation location 5A-07 is card reading interface 103. Since the EPB creation location does not match location 5A-02 as in step 5B-03, then a first set of signals comprising the entered PIN is generated and transmitted to card reading interface 103 via, for example networks 105 in step 5B-05.
As in step 5B-06, the PAN is transmitted to the EPB creation subsystem within the card reading interface 103 since location 5A-07 matches location 5A-04.
As in step 5B-07, the EPB creation subsystem in payment application 102-4 receives the first set of signals, and extracts the PIN.
As in step 5B-08, the EPB creation subsystem then creates the EPB based on the extracted PIN and the received PAN.
As in step 5B-09, the created EPB is then transmitted to server 106 via, for example, networks 105 for PIN verification.

In yet another example embodiment which uses online verification:
As in step 5B-01, the entered PIN is received at the user device 110. Then one or more devices 110 corresponds to PIN reception location 5A-02.
As in step 5B-02, the PAN is received from payment card 104 at card reading interface 103. Then, card reading interface 103 corresponds to PAN reception location 5A-04.
The EPB creation location 5A-07 is user device 110. Since the EPB creation location matches location 5A-02 as in step 5B-03, then the entered PIN is transmitted to the EPB creation subsystem within user device 110 in accordance with step 5B-04.
As in step 5B-06, depending on the encryption capabilities of card reading interface 103, the generation of the second set of signals comprises:
   either encrypting the PAN at card reading interface 103 as part of the generation of the second set of signals, from where it is then transmitted; or
   relaying the PAN to payment application 102-4 via connections 107 for encryption as part of the generation of the second set of signals at the payment application 102-4, from where it is then transmitted.
As in step 5B-07, the EPB creation subsystem in user device 110 receives the PIN and the second set of signals. The EPB creation subsystem extracts the PAN from the second set of signals, wherein the extraction comprises decryption of the encrypted PAN.
As in step 5B-08, the EPB creation subsystem then creates the EPB using the received PIN and the extracted PAN.
As in step 5B-09, the created EPB is then transmitted to server 106 via, for example, networks 105 for PIN verification.

In yet another example embodiment which uses online verification:
As in step 5B-01, the entered PIN is received at the user device 110. Then one or more devices 110 corresponds to PIN reception location 5A-02.
As in step 5B-02, the PAN is received from payment card 104 at card reading interface 103. Then, card reading interface 103 corresponds to PAN reception location 5A-04.
The EPB creation location 5A-07 is server 106. Since the EPB creation location does not match location 5A-02 as in step 5B-03, then a first set of signals comprising the entered PIN is generated and transmitted to server 106 via, for example, networks 105 in step 5B-05.
As in step 5B-06, depending on the encryption capabilities of card reading interface 103, the generation of the second set of signals comprises:
   either encrypting the PAN at card reading interface 103 as part of the generation of the second set of signals, from where it is then transmitted; or
   relaying the PAN to payment application 102-4 via connections 107 for encryption as part of the generation of the second set of signals at the payment application 102-4, from where it is then transmitted.
As in step 5B-07, the EPB creation subsystem in server 106 receives the first and the second set of signals. The EPB creation subsystem extracts the PIN from the first set of signals; and the PAN from the second set of signals, wherein the extraction comprises decryption of the encrypted PAN.
As in step 5B-08, the EPB creation subsystem then creates the EPB using the received PIN and the extracted PAN.
As in step 5B-09, the created EPB is then used by server 106 for PIN verification.

An example embodiment which uses offline PIN verification is as follows:
As in step 5B-01, the entered PIN is received at the user device 110. Then user device 110 corresponds to PIN reception location 5A-02.
As in step 5B-02, the PAN is received from payment card 104 at card reading interface 103. Then, card reading interface 103 corresponds to PAN reception location 5A-04.
The EPB creation location 5A-07 is payment application 102-4. Since the EPB creation location does not match location 5A-01 as in step 5B-03, then a first set of signals comprising the entered PIN is generated and transmitted to payment application 102-4 via, for example networks 105 in step 5B-05.
As in step 5B-06, A second set of signals comprising the PAN is generated and transmitted to payment application 102-4 via connections 107.
As in step 5B-07, the EPB creation subsystem in payment application 102-4 receives the first and second sets of signals, and extracts the PIN and PAN.
As in step 5B-08, the EPB creation subsystem then creates the EPB based on the extracted PIN and the received PAN.
As in step 5B-09, the created EPB is then transmitted to card reading interface 103 via, for example, networks 105 or connections 107, where it is used for offline PIN verification using payment card 104.

Another example embodiment which uses offline PIN verification is as follows:
As in step 5B-01, the entered PIN is received at the user device 110. Then user device 110 corresponds to PIN reception location 5A-02.
As in step 5B-02, the PAN is received from payment card 104 at card reading interface 103. Then, card reading interface 103 corresponds to PAN reception location 5A-04.
The EPB creation location 5A-07 is card reading interface 103. Since the EPB creation location does not match location 5A-01 as in step 5B-03, then a first set of signals comprising the entered PIN is generated by the user device 110 and transmitted to card reading interface 103 via, for example networks 105 in step 5B-05.
As in step 5B-06, the PAN is transmitted to the EPB creation subsystem within card reading interface 103.
As in step 5B-07, the EPB creation subsystem within card reading interface 103 receives the first set of signals, and extracts the PIN. The EPB creation subsystem also receives the PAN.
As in step 5B-08, the EPB creation subsystem then creates the EPB based on the extracted PIN and the received PAN.
As in step 5B-09, the created EPB is then used by card reading interface 103 for offline PIN verification using payment card 104.

In one example embodiment, a system for conducting a card transaction comprises a consumer application running on a user device, a card reading interface separate from the user device, a payment application residing on a commercial-off-the-shelf (COTS) device, a personal identification number (PIN) verification subsystem, an encrypted PIN block (EPB) creation subsystem located at an EPB creation location, and a server, wherein the user device, the card reading interface, the COTS device, the EPB creation subsystem and the server are coupled via at least one of a network or a connection, the user device receives an entered PIN, the card reading interface receives a personal account number (PAN) from a payment card, either the PIN or a first set of signals comprising the PIN is received by the EPB creation subsystem, wherein the first set of signals is generated by the user device and transmitted to the EPB creation subsystem via the network, either the PAN or a second set of signals comprising the PAN is received by the EPB creation subsystem, wherein either the second set of signals is generated and transmitted by the card reading interface via one of the network or the connection, or the PAN is relayed to the payment application via at least one of the network and the connection, and the second set of signals comprising the PAN is generated and transmitted by the payment application via the network, an EPB is created by the EPB creation subsystem based on the PIN and the PAN, and the EPB is transmitted by the EPB creation subsystem to either the PIN verification subsystem or the payment card for PIN verification.

In one or more of the above examples, the user device is located at a PIN reception location; and the first set of signals comprising the PIN is received by the EPB creation subsystem when the PIN reception location does not match the EPB creation location.

In one or more of the above examples, the user device is located at a PIN reception location; and the PIN is received by the EPB creation subsystem when the PIN reception location matches the EPB creation location.

In one or more of the above examples, the card reading interface is located at a PAN reception location, and the PAN is received by the EPB creation subsystem when the PAN reception location matches the EPB creation location.

In one or more of the above examples, the card reading interface is located at a PAN reception location, and the second set of signals comprising the PAN is received by the EPB creation subsystem when the PAN reception location does not match the EPB creation location.

In one or more of the above examples, the generation of the first set of signals comprises encryption of the PIN.

In one or more of the above examples, the generation of the second set of signals comprises encryption of the PAN.

In one or more of the above examples, the EPB extracts at least one of the PIN and the PAN from at least one of the first set of signals and the second set of signals prior to creating the EPB.

In one or more of the above examples, the PAN is relayed to the payment application via at least one of the network and the connection, and the second set of signals comprising the PAN is generated and transmitted by the payment application when the card reading interface does not have an encryption capability.

In one or more of the above examples, the second set of signals comprising the PAN is generated and transmitted by the card reading interface when the card reading interface has an encryption capability.

In another example embodiment, a system for location diversification of performance of a card transaction comprises a personal identification number (PIN) reception subsystem at a PIN reception location, a personal account number (PAN) reception subsystem at a PAN reception location, wherein the PIN reception location is different from the PAN reception location, a payment application residing on a commercial-off-the-shelf (COTS) device, a PIN verification subsystem, an encrypted PIN block (EPB) creation subsystem located at an EPB creation location, and a server, wherein the PIN reception subsystem, the PAN reception subsystem, the COTS device, the EPB creation subsystem and the server are coupled via at least one of a network or a connection, the PIN reception subsystem receives an entered PIN, the PAN reception subsystem receives a PAN from a payment card, either the PIN or a first set of signals comprising the PIN is received by the EPB creation subsystem, wherein the first set of signals is generated and transmitted to the EPB creation subsystem via the network, either the PAN or a second set of signals comprising the PAN is received by the EPB creation subsystem, wherein either the second set of signals is generated and transmitted by the card reading interface via one of the network or the connection, or the PAN is relayed to the payment application via at least one of the network and the connection, and the second set of signals comprising the PAN is generated and transmitted by the payment application via the network, an EPB is created by the EPB creation subsystem based on the PIN and the PAN, and the EPB is transmitted by the EPB creation subsystem to either the PIN verification subsystem or the payment card for PIN verification.

In one or more of the above examples, the first set of signals comprising the PIN is received by the EPB creation subsystem when the PIN reception location does not match the EPB creation location.

In one or more of the above examples, the PIN is received by the EPB creation subsystem when the PIN reception location matches the EPB creation location.

In one or more of the above examples, the PAN is received by the EPB creation subsystem when the PAN reception location matches the EPB creation location.

In one or more of the above examples, the second set of signals comprising the PAN is received by the EPB creation subsystem when the PAN reception location does not match the EPB creation location.

In one or more of the above examples, the generation of the first set of signals comprises encryption of the PIN.

In one or more of the above examples, the generation of the second set of signals comprises encryption of the PAN.

In one or more of the above examples, the EPB extracts at least one of the PIN and the PAN from at least one of the first set of signals and the second set of signals prior to creating the EPB.

In one or more of the above examples, the second set of signals comprising the PAN is generated and transmitted by the PAN when the PAN reception subsystem has an encryption capability.

In another example embodiment, a method for conducting a card transaction comprises receiving, by a personal identification number (PIN) reception subsystem, an entered PIN, receiving, by a personal account number (PAN) reception subsystem, a PAN from a payment card, receiving, by an encrypted PIN block (EPB) creation subsystem, either the PIN or a first set of signals comprising the PIN wherein the first set of signals is generated by the PIN reception subsystem and transmitted to the EPB creation subsystem, receiving, by the EPB creation subsystem, either the PAN or a second set of signals comprising the PAN, wherein either the second set of signals is generated and transmitted by the PAN capture subsystem, or the PAN is relayed to a payment application by the PAN reception subsystem, and the second set of signals comprising the PAN is generated and transmitted by the payment application, creating, by the EPB creation subsystem, an EPB based on the PIN and the PAN, and transmitting, by the EPB creation subsystem, the EPB to either a PIN verification subsystem or the payment card for PIN verification.

In one or more of the above examples, the COTS device is coupled to an application store and a terminal management server (TMS) via the network, a vendor uploads the payment application to the application store, and the COTS device downloads the payment application via the network, and after the downloading by the COTS device, said TMS authorizes the COTS device to install and run the downloaded payment application.

In one or more of the above examples, after the payment application is downloaded by said COTS device, said TMS authenticates the payment application.

In one or more of the above examples, prior to the uploading, said vendor encrypts one or more portions of the payment application; and the COTS device obtains a decryption key from the TMS to decrypt said encrypted one or more portions after the authentication and authorization.

In one or more of the above examples, said encryption is operative to: either prevent exposure of the one or more portions of the payment application outside a trusted environment, or prevent the payment application from performing critical or sensitive operations in unauthorized platforms.

In one or more of the above examples, a PIN pad having one or more display parameters is displayed by the consumer application on a display associated with the user device, and the user device comprises a randomization subsystem to randomly select one or more variables related to at least one of the one or more display parameters, wherein the one or more display parameters include a location of a keypad relative to an edge of the display, a size of the keypad, one or more sizes of one or more buttons within the keypad, and one or more positions of one or more groups of the one or more buttons within the keypad.

In another example embodiment, a system for conducting a card transaction comprises a consumer application running on a user device, a card reading interface separate from the user device, a payment application residing on a commercial-off-the-shelf (COTS) device, a personal identification number (PIN) verification subsystem, an encrypted PIN block (EPB) creation subsystem located at an EPB creation location, and a server, wherein the user device, the card reading interface, the COTS device, the EPB creation subsystem and the PIN verification subsystem are coupled via at least one of a network or a connection, the user device receives an entered PIN, the card reading interface receives a personal account number (PAN) from a payment card, either the PIN or a first set of signals comprising the PIN is received by the EPB creation subsystem, wherein the first set of signals is generated by the user device and transmitted to the EPB creation subsystem via the network, an EPB is created by the EPB creation subsystem based on the PIN, and the EPB is transmitted by the EPB creation subsystem to either the PIN verification subsystem or the payment card for PIN verification.

It will be appreciated by those skilled in the art having the benefit of this disclosure that this a system and a method for personal identification number entry in a commercial off the shelf communication device provides a way for secure PIN entry. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1-26. (canceled)

27. A system for conducting a card transaction, comprising:
a first subsystem at a first location that receives a personal identification number (PIN) entered by a user;
a second subsystem at a second location that receives a personal account number (PAN) from a payment card, wherein the first location is different from the second location;
a third subsystem at a third location that: receives the PIN and the PAN, creates an encrypted PIN block (EPB) based on the PIN and the PAN, and transmits the EPB to either a PIN verification subsystem or the payment card for PIN verification; and
wherein: the first subsystem, the second subsystem, and the third subsystem are coupled via at least one of a network or a connection.

28. The system of claim 27, wherein the third subsystem receives the PIN comprised in a first set of signals when the first location does not match the third location, and wherein the first set of signals is generated and transmitted by the first subsystem to the third subsystem via the network.

29. The system of claim 28, wherein generation of the first set of signals comprises encryption of the PIN.

30. The system of claim 28, wherein the third subsystem extracts the PIN from the first set of signals prior to creating the EPB.

31. The system of claim 27, wherein the PIN is received by the third subsystem when the first location matches the third location.

32. The system of claim 27, wherein the PAN is received by the third subsystem when the second location matches the third location.

33. The system of claim 27, wherein the third subsystem receives the PAN comprised in a second set of signals when the second location does not match the third location.

34. The system of claim 33, wherein either:
the second set of signals comprising the PAN is generated and transmitted by a card reading interface of the second subsystem via one of the network or the connection, or
the PAN is relayed by the second subsystem to a payment application via at least one of the network and the connection, and the second set of signals comprising the PAN is generated and transmitted by the payment application via the network.

35. The system of claim 34, wherein the generation of the second set of signals comprises encryption of the PAN.

36. A method for conducting a card transaction, comprising:
receiving, by a first subsystem at a first location, a personal identification number (PIN) entered by a user;
receiving, by a second subsystem at a second location, a personal account number (PAN) from a payment card, wherein the first location is different from the second location;
receiving, by a third subsystem at a third location, the PIN and the PAN;
creating, by the third subsystem, an encrypted PIN block (EPB) based on the PIN and the PAN;
transmitting, by the third location, the EPB to either a PIN verification subsystem or the payment card for PIN verification; and
wherein: the first subsystem, the second subsystem, and the third subsystem are coupled via at least one of a network or a connection.

37. The method of claim 36, wherein the third subsystem receives the PIN comprised in a first set of signals when the first location does not match the third location, and wherein the first set of signals is generated and transmitted by the first subsystem to the third subsystem via the network.

38. The method of claim 36, wherein the PIN is received by the third subsystem when the first location matches the third location.

39. The method of claim 36, wherein the PAN is received by the third subsystem when the second location matches the third location.

40. The method of claim 36, wherein the third subsystem receives the PAN comprised in a second set of signals when the second location does not match the third location.

41. The method of claim 36, further comprising:
generating and transmitting, by a card reading interface of the second subsystem via one of the network or the connection, the second set of signals comprising the PAN; or
relaying, by the second subsystem to a payment application via at least one of the network and the connection, the PAN, and generating and transmitting, by the payment application via the network, the second set of signals comprising the PAN.

42. A non-transitory machine readable medium having instructions stored thereon which, when executed by a system, causes the system to perform operations for conducting a card transaction, the operations comprising:
receiving, by a first subsystem at a first location, a personal identification number (PIN) entered by a user;
receiving, by a second subsystem at a second location, a personal account number (PAN) from a payment card, wherein the first location is different from the second location;
receiving, by a third subsystem at a third location, the PIN and the PAN;
creating, by the third subsystem, an encrypted PIN block (EPB) based on the PIN and the PAN;
transmitting, by the third location, the EPB to either a PIN verification subsystem or the payment card for PIN verification; and
wherein: the first subsystem, the second subsystem, and the third subsystem are coupled via at least one of a network or a connection.

43. The non-transitory machine readable medium of claim 42, wherein the third subsystem receives the PIN comprised in a first set of signals when the first location does not match the third location, and wherein the first set of signals is generated and transmitted by the first subsystem to the third subsystem via the network.

44. The non-transitory machine readable medium of claim 42, wherein the PIN is received by the third subsystem when the first location matches the third location.

45. The non-transitory machine readable medium of claim 42, wherein the PAN is received by the third subsystem when the second location matches the third location.

46. The non-transitory machine readable medium of claim 42, wherein the third subsystem receives the PAN comprised in a second set of signals when the second location does not match the third location.
